(19) United States
(12) Patent Application Publication
(10) Pub. No.: US 2017/0006359 A1
(43) Pub. Date: Jan. 5, 2017

(54) WIRELESS COMMUNICATION DEVICE, WIRELESS COMMUNICATION TERMINAL, AND WIRELESS COMMUNICATION METHOD

(71) Applicant: Kabushiki Kaisha Toshiba, Minato-ku (JP)

(72) Inventors: Toshihisa NABETANI, Kawasaki (JP); Ryoko MATSUO, Shinagawa (JP); Toshiyuki NAKANISHI, Yokohama (JP); Hirokazu TANAKA, Bunkyo (JP)

(73) Assignee: Kabushiki Kaisha Toshiba, Minato-ku (JP)

(21) Appl. No.: 15/266,456

(22) Filed: Sep. 15, 2016

Related U.S. Application Data
(63) Continuation of application No. PCT/JP2015/066784, filed on Jun. 10, 2015.

(30) Foreign Application Priority Data
Jun. 10, 2014 (JP) 2014-119852

(51) Int. Cl. H04Q 9/00

(52) U.S. Cl. CPC H04Q 9/00; H04Q 2209/43

(57) ABSTRACT

A wireless communication device according to one embodiment includes a receiver, processing circuitry and a transmitter. The receiver receives a first signal obtained by a first sensor. The processing circuitry compares first sensing information included in the first signal with second sensing information obtained by a second sensor so as to determine whether or not the first sensing information and the second sensing information are obtained from a same target object. In addition, the transmitter transmits a wireless connection signal, when it is determined that the first sensing information and the second sensing information are obtained from the same target object. The wireless connection signal is a signal to connect one of an own device and an other communication device which has transmitted the first signal to a wireless network formed by the other of the own device and the other communication device.

### CROSS REFERENCE TO RELATED APPLICATION

This application is a Continuation of International Application No. PCT/JP2015/66784, filed on Jun. 10, 2015, the entire contents of which is hereby incorporated by reference.

### FIELD

Embodiments described herein relate to a wireless communication device, a wireless communication terminal, and a wireless communication method.

### BACKGROUND

In the presence of a plurality of hubs (hereinafter also referred to as access points) forming a wireless network, when an access point which each wireless communication terminal newly connects to is selected, it is known to make a selection based on received signal intensities from respective access points. For example, there is a method of selecting an access point with the largest received signal intensity among received signal intensities from respective access points. By thus selecting an access point with the largest received signal intensity, the wireless communication terminal can perform stable and high-speed wireless communication.

Further, when the wireless communication terminal selects an access point of wireless LAN (Local Area Network), a list of access points with a received signal intensity equal to or higher than a certain level may be displayed on a screen together with SSID (Service Set Identifier). In this case, the user of the wireless communication terminal selects a desired access point from the displayed ones, so as to connect to the selected access point.

However, the method of selecting an access point with the largest received signal intensity among received signal intensities from respective access points may cause the wireless communication terminal to join a wireless network other than the wireless network desired by the user. On the other hand, when the wireless communication terminal includes no display for the purpose of size reduction and power consumption reduction, the method of selecting a desired access point from ones displayed on a screen cannot be used.

### BRIEF DESCRIPTION OF THE DRAWINGS

FIG. 1 is a diagram illustrating a configuration of a communication system in a first embodiment;

FIG. 2 is a diagram illustrating a configuration of a communication device 1 as a hub in the first embodiment;

FIG. 3 is a diagram illustrating a configuration of a communication device 2 as a node in the first embodiment;

FIG. 4 is a flowchart illustrating one example of processing of establishing connection in the first embodiment;

FIG. 5 is a diagram illustrating an example of a result of scanning by a communication device 2-1 for a certain period of time;

FIG. 6 is a diagram illustrating a configuration of a communication device is as a hub in a modification example of the first embodiment;

FIG. 7 is a diagram illustrating a configuration of a communication device 1b as a hub in a second embodiment;

FIG. 8 is a flowchart illustrating one example of processing of establishing connection in the second embodiment;

FIG. 9 is a diagram illustrating a configuration of a communication device is as a hub in a third embodiment;

FIG. 10 is a diagram illustrating a configuration of a communication device 2c as a node in the third embodiment;

FIG. 11 is a flowchart illustrating one example of processing of establishing connection in the third embodiment;

FIG. 12 is a diagram illustrating a configuration of a communication device 1d as a hub in a fourth embodiment;

FIG. 13 is a diagram illustrating a configuration of a communication device 2d as a node in the fourth embodiment;

FIG. 14 is a flowchart illustrating one example of processing of establishing connection in the fourth embodiment;

FIG. 15 is a diagram illustrating a hardware configuration example of the communication device 1 according to the first embodiment;

FIG. 16 is a diagram illustrating a hardware configuration example of the communication device 2 according to the first embodiment;

FIG. 17A and FIG. 17B are perspective views of wireless communication terminals according to a sixth embodiment;

FIG. 18 is a view illustrating a memory card according to the sixth embodiment;

FIG. 19 is a diagram illustrating a wireless communication system according to a fifteenth embodiment;

FIG. 20 is a hardware block diagram of a node according to the fifteenth embodiment; and

FIG. 21 is a hardware block diagram of a hub according to the fifteenth embodiment.

### DETAILED DESCRIPTION

The problem to be solved by embodiments described herein is to improve the probability of joining a desired wireless network.

A wireless communication device according to one embodiment includes a receiver, processing circuitry and a transmitter. The receiver receives a first signal obtained by a first sensor. The processing circuitry compares first sensing information included in the first signal with second sensing information obtained by a second sensor so as to determine whether or not the first sensing information and the second sensing information are obtained from a same target object. In addition, the transmitter transmits a wireless connection signal, when it is determined that the first sensing information and the second sensing information are obtained from the same target object as a result of the determination. The wireless connection signal is a signal to connect one of an own device and an other communication device which has transmitted the first signal to a wireless network formed by the other of the own device and the other communication device.

In a wireless network formed in surroundings of an object, the object itself may become a shielding against wireless communication, and a hub with the largest received signal intensity is not necessarily a hub forming the wireless network in the surroundings of the object. Accordingly, when it is desired to allow a wireless communication terminal to connect to a hub forming a wireless network in surroundings of a certain object, if the wireless communication terminal selects a hub to connect based on received signal intensities, it is possible to connect to another hub forming another wireless network in surroundings of an object close to the certain object.

Further, in order to obtain sensing information by a sensor incorporated in a communication device (also called a wireless communication device), an application of placing and using the communication device on an object is assumed. In this case, for the purpose of size reduction and power consumption reduction, there may be cases where a display part displaying a list of hubs with received signal intensities equal to or higher than a certain level is not provided. In such cases, the user cannot see a screen for selecting a desired hub. Accordingly, in each embodiment, the communication device is configured to connect to a hub placed on the same target object as a target object on which the communication device is placed, to thereby improve the probability of joining a desired wireless network.

In each embodiment, as one example of a wireless network formed in surroundings of an object, a body area network (BAN) as a wireless network formed around a human will be used for explanation. Here, it is assumed that, in the body area network, the hub allows connection of only a node placed on the same person as the person on whom the own device is placed. Hereinafter, embodiments of the present invention will be explained with reference to drawings.

Note that first sensing information and second sensing information in each embodiment may be measurement values of a sensor, characteristic amounts extracted from measurement values of a sensor, or hush values of these measurement values or characteristic amounts.

### First Embodiment

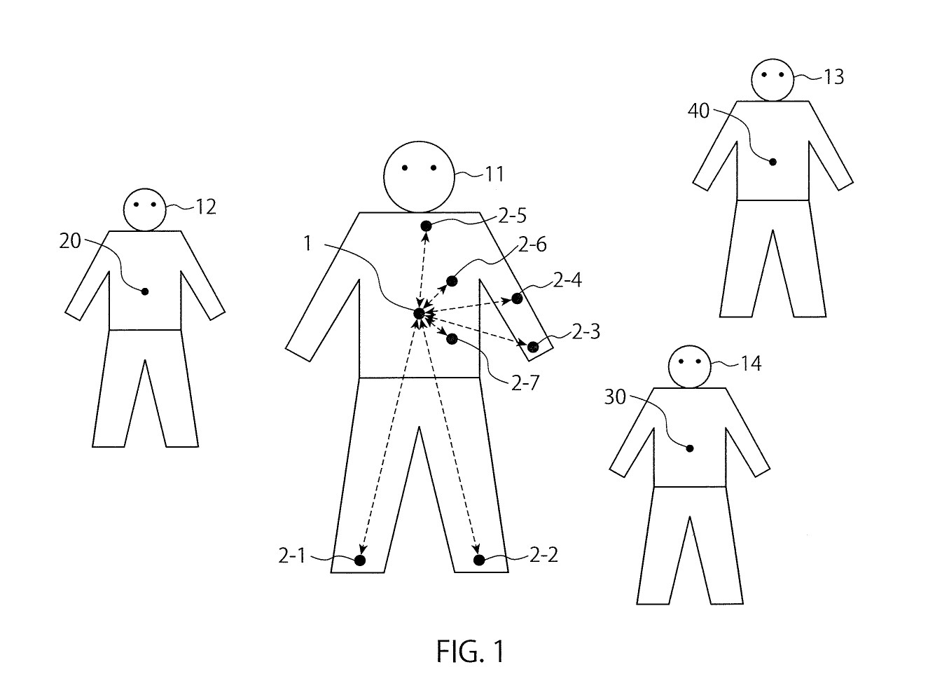

FIG. 1 is a diagram illustrating a configuration of a communication system in a first embodiment. As illustrated in FIG. 1, the communication system in the first embodiment has a communication device 1 as a hub, and seven communication devices 2-i (i is an integer from 1 to 7) of communication devices 2-1, . . . , 2-7 as nodes. Note that the number of communication devices 2-i as nodes is not limited to seven and may be six or less or eight or more.

As illustrated in FIG. 1, the communication device 1 as the hub is placed in, for example, a center region of a person 11. Further, the communication devices 2-1, . . . , 2-7 as nodes are placed in, for example, regions of the person 11 which are different from each other. Further, as illustrated in FIG. 1, for example, a communication device 20 forming another wireless network is placed on a person 12, a communication device 30 forming another wireless network is placed on a person 13, and a communication device 40 forming another wireless network is placed on a person 14.

Note that placing on a person can also include, besides fixedly attaching in a region (finger or wrist, inside body, or the like) of a person, a state of disposing near the user such as placing on a neck strap, holding by a hand, putting in a user's possession such as a pocket of clothes or a bag.

The communication system of each embodiment is not limited to the body area network and can be applied to any network as long as it is a network allowing mutual communication through a hub and nodes disposed. For example, the hub and nodes may be placed on a living body other than a human, such as an animal or plant, or may be placed in a plurality of positions of an object other than a living body, for example, an automobile (such as a body and wheels).

The communication device 1 as the hub communicates with the communication devices 2-1, . . . , 2-7 as nodes. For example, the communication device 1 as the hub has at least one or more sensors to measure predetermined information in the region where the communication device 1 is placed. In this embodiment, the communication device 1 as the hub measures biological information of the person on whom the own device is placed as one example of information related to the object on which the own device is placed. Here, the biological information is, for example, body temperature, blood pressure, pulse wave, electrocardiogram, heart rate, blood oxygen level, glucose in urine, blood glucose, body motion, or body direction or the like but is not limited thereto.

Further, in the first embodiment, information obtained by measurement by a sensor placed on an object will be referred to as sensing information. Here, the sensing information is a measurement value of the sensor (for example, raw data of biometrics information such as pulse waves) or a characteristic amount (for example, a time interval of peaks of pulse waves) extracted from measurement values of the sensor.

The communication device 1 as the hub transmits a beacon signal periodically to the communication devices 2-1, . . . , 2-7 as nodes, the beacon signal including wireless communication parameters necessary for communication and sensing information obtained by measurement by the sensor. Note that the wireless transmission of the beacon signal is performed by broadcast as one example.

The communication devices 2-1, . . . , 2-7 as nodes wirelessly obtain wireless communication parameters and the like from the hub.

Further, the communication devices 2-1, . . . , 2-7 as nodes have at least one or more sensors, so as to measure biometrics information in the regions where the communication devices 2-1, . . . , 2-7 as nodes are disposed. Then, the communication devices 2-1, . . . , 2-7 as nodes wirelessly transmit sensing information obtained by measurement by the sensor to the communication device 1 as the hub. Thus, sensing information obtained in nodes is aggregated in the hub.

The communication devices 2-1, . . . , 2-7 as nodes differ in, as one example, types of provided sensors from each other, and their fitting positions on a person differ from each other depending on a sensing application or the like. Hereinafter, the communication devices 2-1, . . . , 2-7 as nodes will be generically called a communication device 2.

As sensors which hubs and nodes have, for example, a sleep sensor, an acceleration sensor, an electrocardiogram sensor, a body temperature sensor, a blood pressure sensor, a pulse sensor, a heart rate sensor, a blood oxygen level sensor, a urine glucose sensor, a blood glucose sensor, an azimuth sensor, and the like are conceivable. The acceleration sensor detects a body motion of the person on whom this acceleration sensor is placed. The azimuth sensor detects the direction of the person on whom the azimuth sensor is placed.

(Configuration of the Communication Device 1 as the Hub)

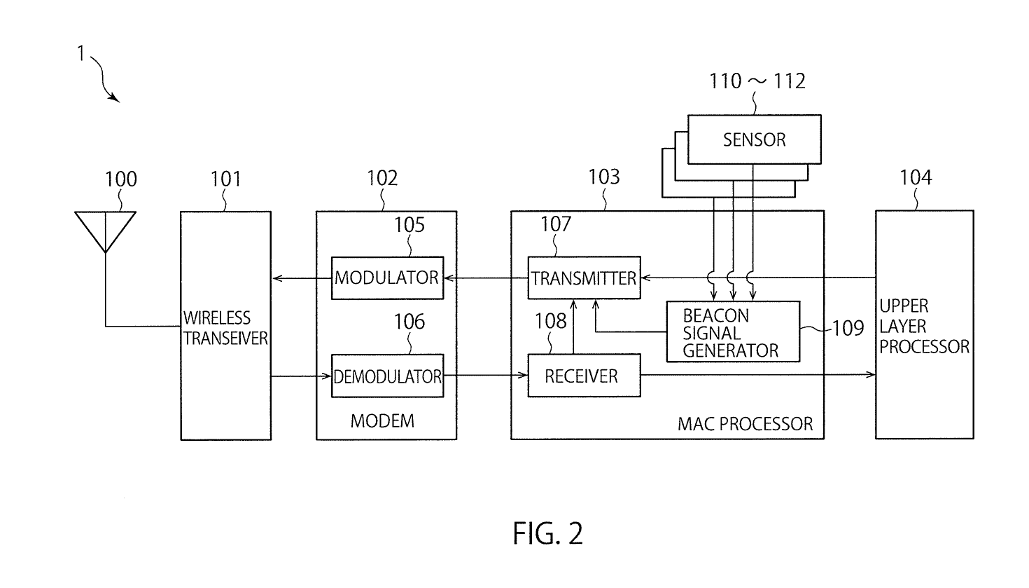

Next, a configuration of the communication device 1 as the hub will be explained using FIG. 2. As illustrated in FIG. 2, the communication device 1 as the hub has an antenna 100, a wireless transceiver 101 connected to the antenna 100, a modem 102 connected to the wireless transceiver 101, a MAC processor 103 connected to the modem 102, an upper layer processor 104 connected to the MAC processor 103, and sensors 110, . . . , 112.

The antenna 100 is an antenna for wireless communication.

The modem 102 modulates a signal inputted from the MAC processor 103 and demodulates a signal inputted from the wireless transceiver 101. Here, the modem 102 includes a modulator 105 and a demodulator 106.

The MAC processor 103 executes processing in a MAC (Media Access Control) layer. Here, the MAC processor 103 has a transmitter 107, a receiver 108, and a beacon signal generator 109. The MAC processor 103 is equivalent to one example of a baseband integrated circuit or a controller performing processing related to communication with another communication device or another wireless communication terminal. The function of a baseband integrated circuit or a controller may be carried out by software (program) operating in a processor such as a CPU, or may be carried out by hardware, or may be carried out both by software and hardware. The software may be stored in a recording medium such as a memory such as ROM or RAM, a hard disk, or an SSD, to be read and executed by the processor. The memory may be either volatile memory such as DRAM or non-volatile memory such as NAND or MRAM.

The upper layer processor 104 outputs a data frame when the data frame is transmitted. This data frame is stored in a transmission buffer (not illustrated) in the transmitter 107. Here, in the data frame, data other than those of sensing (for example, time information, information received by the hub via the Internet, and so on) are stored.

The transmitter 107 performs processing of adding a predetermined MAC header on the data frame stored in the transmission buffer, and thereafter outputs a signal after the processing to the modulator 105.

The modulator 105 performs predetermined physical layer processing such as modulation processing and adding a physical header on the frame inputted from the transmitter 107, and outputs a signal after the physical layer processing to the wireless transceiver 101.

The wireless transceiver 101 performs D/A conversion of the signal after the physical layer processing, further performs frequency conversion thereof, and thereafter transmits a frame to a communication device 2-i of any connected node via the antenna 100. The wireless transceiver 101 is equivalent to one example of a wireless communication part or an RF integrated circuit which transmits and receives a signal via the antenna 100.

The integrated circuit for wireless communication according to this embodiment may include at least the former of the baseband integrated circuit and the RF integrated circuit. As described above, the MAC processor 103 may be constituted of the baseband integrated circuit. The wireless transceiver 101 may be constituted of the RF integrated circuit.

Each of the sensors 110, . . . , 112 is a sensor for sensing biometrics information which is different from each other, for example, blood pressure and electrocardiogram. Each of the sensors 110, . . . , 112 measures biometrics information and outputs sensing information obtained by measurement to the beacon signal generator 109.

Note that in the first embodiment, the communication device 1 as the hub has three types of sensors as one example, but the number of sensors is not limited to this and may be two types or less or four types or more.

The beacon signal generator 109 periodically obtains the sensing information inputted from each of the sensors 110, . . . , 112. Then, the beacon signal generator 109 periodically generates a beacon signal in which the obtained sensing information is included in a specific field in the beacon signal. The beacon signal generator 109 then periodically outputs this beacon signal to the transmitter 107.

Here, the sensing information included in the beacon signal by the beacon signal generator 109 may be any information as long as it is information which can identify an individual and is information different in every individual.

The transmitter 107, similarly to when the data frame is transmitted, performs processing of adding a predetermined MAC header to the beacon signal, and so on, and thereafter outputs a signal after the processing to the modulator 105.

Thereafter, the modulator 105 performs predetermined physical layer processing such as modulation processing and adding a physical header on the signal after the processing, and outputs a signal after the physical layer processing to the wireless transceiver 101.

The wireless transceiver 101 performs D/A conversion of the signal after the physical layer processing, further performs frequency conversion thereof, and thereafter transmits the signal by broadcast via the antenna 100.

On the other hand, processing when the frame is received from the connected communication device 2 as a node will be explained below.

After performing frequency conversion to the base band on a signal received via the antenna 100, the wireless transceiver 101 performs A/D conversion thereof and outputs an obtained signal to the demodulator 106.

The demodulator 106 performs demodulation processing and predetermined physical layer processing such as analyzing a physical header, and outputs a signal after the physical layer processing to the receiver 108.

The receiver 108 performs analyzing a MAC header of a demodulated frame, or the like. Then, the receiver 108 extracts sensing information or the like transmitted from the communication device 2 as a node as necessary (for example, when transmitting to a cloud via the Internet), and outputs the extracted sensing information to the upper layer processor 104. Thus, the communication device 1 as the hub can transmit, for example, the sensing information to a cloud.

Further, when a result of analyzing the MAC header is that the received signal (for example, a frame) is a connection request signal (for example, a connection request frame) transmitted from the node, the receiver 108 transmits from the transmitter 107 to this node a response signal (for example, a response frame) or the like with respect to the connection request signal (for example, a connection request frame).

(Configuration of the Communication Device 2 as a Node)

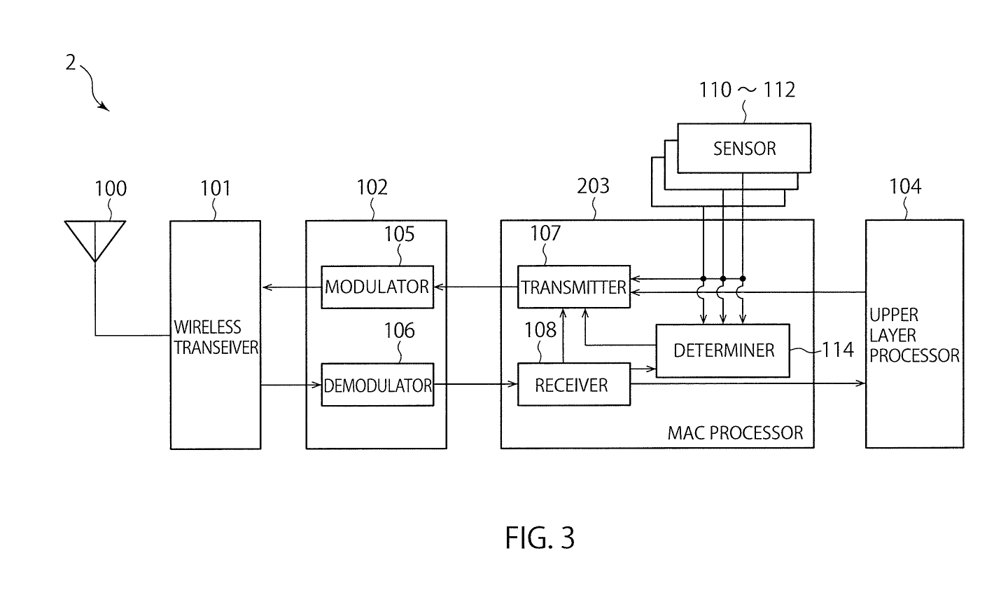

Next, a configuration of the communication device 2 as a node will be explained by using FIG. 3. FIG. 3 is a diagram illustrating the configuration of the communication device 2 as a node in the first embodiment. Note that common elements to those in FIG. 2 are given the same numerals, and specific explanations thereof are omitted.

As illustrated in FIG. 3, the configuration of the communication device 2 as a node is such that the beacon signal generator 109 does not exist in the configuration of the communication device 1 as the hub illustrated in FIG. 2, and a determiner 114 is provided instead. Accompanying this, the MAC processor 103 of FIG. 2 is changed to a MAC processor 203 of FIG. 3.

The determiner 114 obtains from the sensors 110, . . . , 112 sensing information measured and obtained by the sensors 110, . . . , 112.

When the communication device is already connected to the hub, the transmitter 107 obtains the sensing information measured and obtained by the sensors 110, . . . , 112. Then, the transmitter 107 performs predetermined MAC header addition and/or the like to the obtained sensing information, as performed similarly on data normally inputted from the upper layer processor 104, and outputs a signal after the addition to the modulator 105. After performing processing necessary to transmission such as modulation, the modulator 105 outputs a signal after the processing to the wireless transceiver 101. The wireless transceiver 101 performs D/A conversion of the signal after the processing, further performs frequency conversion thereof, and thereafter transmits the signal to the connected hub via the antenna 100.

On the other hand, when the communication device is not connected to the hub yet and newly connecting to the hub, the receiver 108 performs analysis of MAC header on a signal received by the wireless transceiver 101 and thereafter demodulated by the demodulator 106. Consequently, when a received frame is the beacon signal, the receiver 108 refers to a field containing first sensing information in the received beacon signal, and extracts the first sensing information. The receiver 108 outputs the extracted first sensing information to the determiner 114.

Thus, the receiver 108 receives a plurality of transmission signals which include first sensing information measured and obtained by a first sensor (for example, sensors 110, . . . , 112 of FIG. 2) placed on the object and wirelessly transmitted by broadcast. Here, the first sensing information is, for example, a first characteristic amount extracted from measurement values of the sensors 110 to 112 which are the first sensor included in the hub. In this case, the determiner 114 extracts a second characteristic amount as second sensing information from the measurement values of the sensors 110 to 112 which are a second sensor included in the own device.

The determiner 114 compares the first sensing information inputted from the receiver 108 with the second sensing information measured and obtained by the sensors 110, . . . , 112 of the own device, so as to determine whether or not the first sensing information and the second sensing information are information obtained from the same person.

Then, when the determiner 114 determines that the first sensing information and the second sensing information are information obtained from the same person, the transmitter 107 transmits a connection request signal (for example, a connection request frame) to the hub which transmitted the beacon signal.

On the other hand, when the determiner 114 determines that the first sensing information and the second sensing information are not information obtained from the same person, the transmitter 107 does not transmit the connection request signal (for example, a connection request frame) to the hub which transmitted the beacon signal, and the receiver 108 waits for reception of the next beacon signal.

In this manner, the determiner 114 compares each of the plurality of pieces of first sensing information included in a plurality of transmitted signals received with the second sensing information measured and obtained by the second sensor placed on the same object as the object on which the first sensor is placed. Thus, for each transmitted signal received, the determiner 114 determines whether or not sensing information obtained from the same target object as the target object on which the relevant communication device 1 is placed is included.

Then, as a result of determination by the determiner 114, the receiver 108 transmits a wireless connection signal for allowing connection to the wireless network to the other communication device which transmitted the transmitted signal determined to include the first sensing information obtained from the same target object.

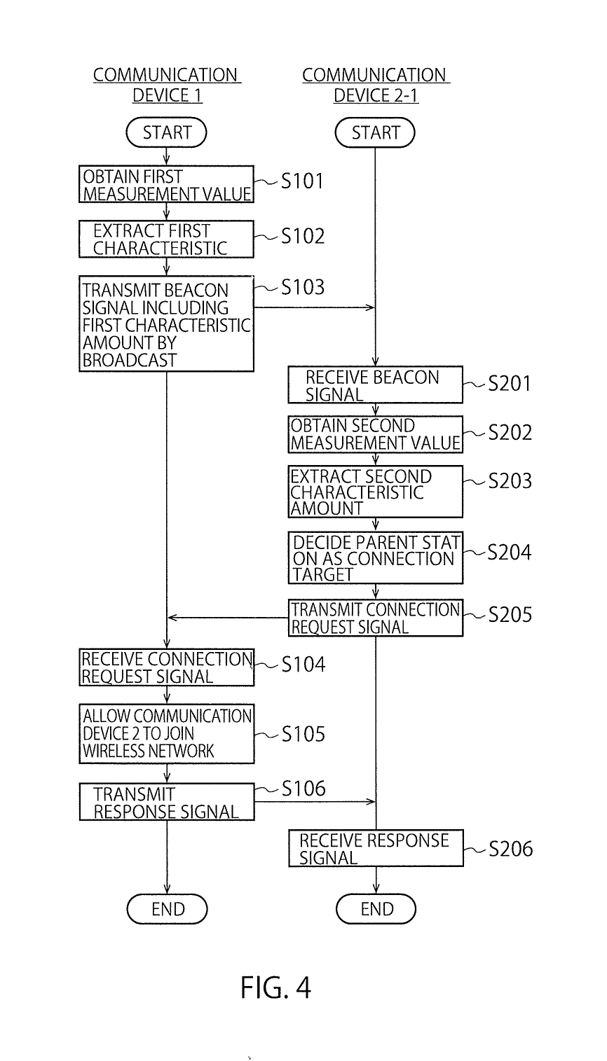

Next, for the communication device 1 and the communication device 2 having the configurations as above, assuming a case that the communication device 2-1 newly joins the wireless network formed by the communication device 1 as the hub, processing of establishing connection will be explained using FIG. 4. FIG. 4 is a flowchart illustrating one example of processing of establishing connection in the first embodiment. Note that the communication devices 2-2, . . . , 2-7 as other nodes are, for example, already connected to the communication device 1 as the hub.

First, processing of the communication device 1 as the hub will be explained.

(Step S101) First, the beacon signal generator 109 of the communication device 1 as the hub obtains a first measurement value measured by the sensor 110 in the own device.

(Step S102) Next, the beacon signal generator 109 of the communication device 1 as the hub extracts a first characteristic amount from the first measurement value obtained in step S101.

(Step S103) Next, the transmitter 107 of the communication device 1 as the hub wirelessly transmits periodically by broadcast a beacon signal including the first characteristic amount of the communication device 1 as the hub.

In this manner, the communication device 1 as the hub periodically transmits the sensing information obtained by measurement by the sensors which the device itself has by including the sensing information in the beacon signal.

Further, the value of the first sensing information to be included in the beacon signal may be, besides a measurement value itself at the time of sampling, a characteristic amount extracted from biometrics information, such as a period of a waveform chronologically representing the measurement value, a variation pattern of peak intervals of the waveform chronologically representing the measurement value, or a rising angle of the waveform chronologically representing the measurement value.

Further, the communication device 1 has a plurality of sensors and may include two or more types of values of the first sensing information in the beacon signal. When the communication device has two or more types of sensors, it is possible to include relative variation values by a combination among different types of sensing information in the beacon signal. The biometrics information included in the beacon signal may be any information as long as it is information which can identify an individual and is information different in every individual.

Thus, the communication device 1 as the hub includes in the beacon signal the first sensing information obtained by one or more sensors which the device itself has, and periodically and wirelessly transmits this beacon signal in the wireless network.

Next, processing of the communication device 2-1 which newly joins the wireless network formed by the communication device 1 will be explained.

(Step S201) Next, the receiver 108 of the communication device 2-1 receives a plurality of beacon signals including the beacon signal transmitted in step S103.

In this manner, the sensors 110 to 112 of the communication device 2-1 starts obtaining second sensing information in the region of the body where it is placed. At the same time, the receiver 108 of the communication device 2-1 performs scanning of the transmitted beacon signals in order to detect any wireless network existing in surroundings for a certain period of time. Specifically, the receiver 108 of the communication device 2-1 refers to the field which includes the first sensing information in each of the received beacon signals, and obtains the first characteristic amount which is one example of the first sensing information from each beacon signal.

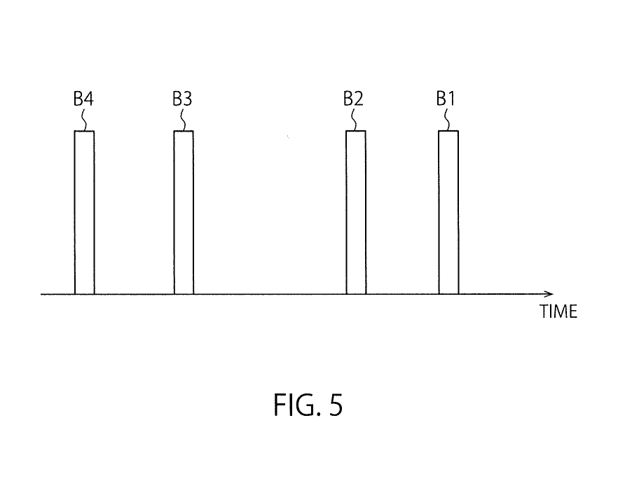

FIG. 5 is a diagram illustrating an example of a result of scanning by the communication device 2-1 for a certain period of time. In the example of FIG. 5, as a result of the scanning for a certain period of time, beacon signals are received from four different communication devices 1, 20, 30, 40. Specifically, in this example, besides a beacon signal B1 transmitted from the communication device 1, beacon signals B2, B3, B4 transmitted from the communication devices 20, 30, 40 as hubs forming other wireless networks not illustrated in FIG. 1 are received.

(Step S202) Next, the determiner 114 of the communication device 2-1 obtains a second measurement value started to be measured by the sensor 110 in the own device.

(Step S203) Next, the determiner 114 of the communication device 2-1 extracts a second characteristic amount from the second measurement value obtained in step S202.

(Step S204) Next, the determiner 114 of the communication device 2-1 compares each of the first characteristic amounts included in the respective beacon signals with the second characteristic amount extracted in step S203. At this time, ones to be compared need not be one and another characteristic amount but may be one and another plurality of characteristic amounts.

By comparing in this manner, the determiner 114 of the communication device 2-1 determines whether or not sensing information obtained from the same person on whom this communication device 2-1 is placed is included in each of the beacon signals received.

The determiner 114 of the communication device 2-1 decides as a hub as the connection target the communication device which has transmitted the beacon signal determined to include the sensing information obtained from the same person on whom this communication device 2-1 is placed as a result of determination. Here, as one example, the communication device 1 is decided as the hub as the connection target.

(Step S205) Then, the transmitter 107 of the communication device 2-1 transmits to the decided hub, namely the communication device 1, a connection request signal requesting for connection to the hub. The connection request signal is, for example, a management frame for a joining request.

In other words, when determined that biometrics information obtained from a different person from the person with the own device is included as a result of comparing the sensing information, the determiner 114 of the communication device 2-1 determines that the communication device which transmitted this beacon signal is not the hub as the connection target. Then, the transmitter 107 of the communication device 2-1 does not request for connection to the communication device of this hub however large its received signal intensity is.

In the example of FIG. 5, when the communication device 2-1 receives beacon signals B2, B3, B4 transmitted from the communication devices 20, 30, 40, respectively, the communication device refers to the field including sensing information in the beacon signals, and compares the referred sensing information with sensing information obtained in the own device. As a result of this comparison, it is proved not to be sensing information obtained from the same person. Accordingly, the communication device 2-1 does not request for connection to the communication devices which transmitted the respective beacon signals.

On the other hand, when the communication device 2-1 receives the beacon signal B1 transmitted from the communication device 1, it is proved to be sensing information obtained from the same person from comparison of sensing information. Accordingly, the communication device 2-1 decides the communication device 1 as the hub as the connection target, and requests for connection to the communication device 1.

Next, processing of the communication device 1 as the hub will be explained.

(Step S104) Next, the receiver 108 of the communication device 1 as the hub receives the connection request signal transmitted in step S205.

(Step S105) Next, the upper layer processor 104 or a not-illustrated management part in the MAC processor 103 of the communication device 1 as the hub executes processing for allowing the communication device 2-1 as a node to join the wireless network.

(Step S106) Next, the transmitter 107 of the communication device 1 as the hub transmits a response signal to the communication device 2-1 as the node.

(Step S206) Next, the receiver 108 of the communication device 2-1 as the node receives the response signal transmitted in step S106.

As described above, when the communication device 2-1 according to the first embodiment newly joins the wireless network formed by the communication device 1, the receiver 108 receives from the communication device 1 as another communication device a transmitted signal including first sensing information obtained by measurement by the first sensor.

The determiner 114 compares the first sensing information included in the received transmitted signal with the second sensing information obtained by measurement by the second sensor, so as to determine whether or not the first sensing information and the second sensing information are obtained from the same target object.

When it is determined that the sensing information is obtained from the same target object as a result of determination, the transmitter 107 transmits to the communication device 1 as another communication device the wireless connection signal (here, the connection request signal as one example) for allowing connection of the own device to the wireless network.

Thus, the sensing information differs in every object, and values of two pieces of sensing information obtained from the same target object coincide or correspond with each other. Thus, the probability of selecting the hub placed on the same target object as the target object on which the communication device is placed can be improved by comparing the sensing information. In other words, the probability of erroneous connection to a hub forming another wireless network existing in the surroundings can be decreased.

Further, when the received transmitted signal includes the sensing information obtained from the same target object as the target object on which the relevant communication device 2-1 is disposed, the communication device which transmitted this transmitted signal is selected as the hub. Thus, the communication device 2-1 can connect to the hub without the user's intervention.

Consequently, the communication device 2-1 according to the first embodiment can improve the probability of connection to the hub placed on the same target object as the target object on which the communication device 2-1 is placed without the user's intervention.

Note that in determination of whether the sensing information obtained from the same person is included or not in the communication device 2-1, the first sensing information and the second sensing information may be of the same type or different types.

For example, in the case of the example of FIG. 1, the sensing information obtained by the communication device 1 as the hub and included in the beacon signal and the sensing information obtained by the communication device 2-1 as a newly connecting node may be ones related to the same type of biometrics information (for example, pulse waves) obtained respectively on the chest (communication device 1) and the right leg (communication device 2-1). On the other hand, they may be different types, such as information related to heart rates on the chest and information related to pulse waves on the right leg.

When the biometrics information is of the same type, the determiner 114 may compare characteristic amounts of biometrics information (for example, pulse waves) measured in respective regions, so as to determine whether or not it is information of the same person.

As described above, when the first sensing information and the second sensing information are ones obtained by measurement by the same types of sensors, for example, when the first sensing information (for example, the first characteristic amount) and the second sensing information (for example, the second characteristic amount) coincide, the determiner 114 may determine that the sensing information obtained from the same target object as the object on which the relevant communication device 2-1 is placed is included in the transmitted signal including the first characteristic amount. The coincidence includes, for example, a case where the characteristic amounts are the same in a certain order, and a case where a difference in characteristic amounts is within a predetermined range.

Note that in this embodiment, the communication device 1 as the hub extracts the characteristic amount from the first sensing information and transmitted it, but it is not limited thus. There may be cases where the communication device 1 transmits, without extracting the characteristic amount, a beacon signal including raw data of the first sensing information. In this case, the communication device 2-1 may extract the first characteristic amount from the first sensing information included in the beacon signal, and then compare the extracted first characteristic amount with a second characteristic amount extracted from second sensing information measured by itself.

On the other hand, even when the biometrics information is of different type, it is known that, for example, heart rates and pulse waves and the like are highly correlated. Thus, a case is assumed where a first sensor which the hub has and a second sensor which a newly connecting node has are sensors of different types whose measurement values have a correlation with each other. In this case, the determiner 114 may compare respective characteristic amounts (for example, variation patterns of measurement values or the like) to determine whether or not two pieces of biometrics information are information obtained from the same person. Here, the variation patterns of measurement values are characteristic amounts decided by using measurement values measured at plural times (for example, time variation of time intervals of peaks, rising angle, and the like).

The determiner 114 may perform determination by thus comparing the variation pattern of measurement values of the first sensor with the variation pattern of measurement values of the second sensor. Specifically, for example, when there is a predetermined correspondence between the variation pattern of measurement values of the first sensor and the variation pattern of measurement values of the second sensor, the determiner 114 may determine that the first sensing information and the second sensing information are information obtained from the same target object.

As described above, the biometrics information used for determination may be of any combination as long as whether or not it is biometrics information obtained from the same person can be determined by the regions where the communication devices are attached or by the types of sensors provided in the communication devices. Accordingly, the determiner 114 may perform determination by combining a plurality of pieces of biometrics information. By performing determination by combining a plurality of pieces of biometrics information, accuracy of determination can be increased.

Further, when whether it is information from the same person or not is determined, if beacon signals in which sensing information coincide do not exist among beacon signals received during a prescribed period, the determiner 114 may decide the communication device which transmitted a beacon signal including sensing information which is closest to the sensing information obtained by the communication device 2-1 in its own device among the received plurality of beacon signals as the hub as the connection target.

Specifically, for example, the determiner 114 may decide as the hub as the connection target the communication device which transmitted a transmitted signal including a characteristic amount which is closest to the second characteristic amount.

As one example of this, the determiner 114 may calculate the difference between the first characteristic amount and the second characteristic amount, and decide as the hub as the connection target the communication device which transmitted a transmitted signal including the first characteristic amount which is smallest in the difference.

Alternatively, the determiner 114 may calculate the difference between the first characteristic amount and the second characteristic amount, and decide as the hub as the connection target the communication device which transmitted a transmitted signal including the first characteristic amount of which the difference is equal to or less than a threshold and also is smallest.

Alternatively, the determiner 114 may calculate the difference between the first characteristic amount and the second characteristic amount, and decide as the hub as the connection target the communication device which transmitted a transmitted signal including the first characteristic amount of which the difference is equal to or less than a threshold.

(Modification Example of the First Embodiment)

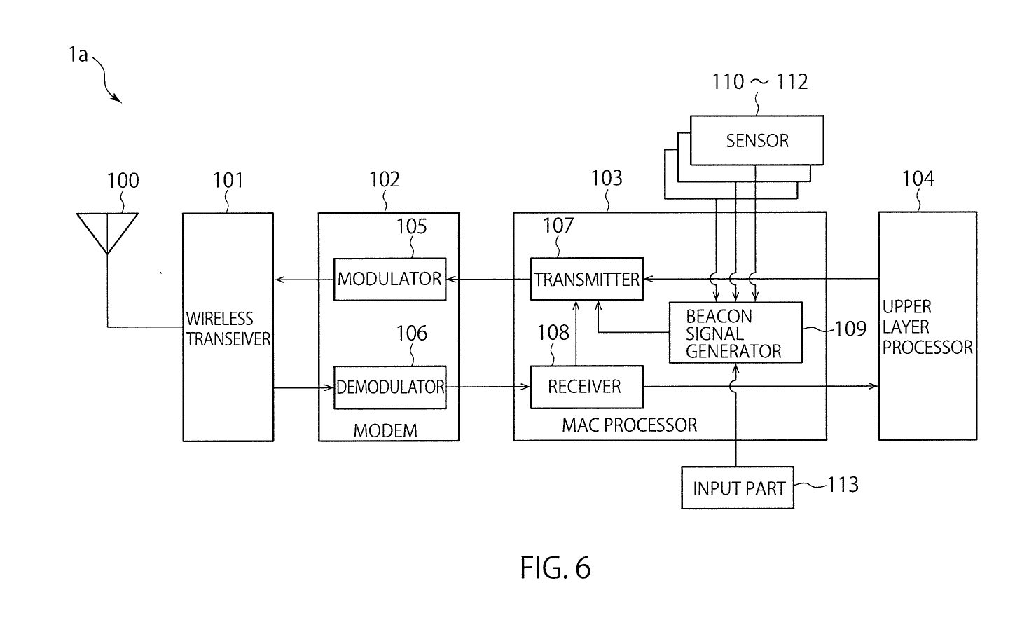

Next, a modification example of the first embodiment will be explained. FIG. 6 is a diagram illustrating a configuration of a communication device is as a hub in the modification example of the first embodiment. Note that common elements to those in FIG. 2 are given the same numerals, and specific explanations thereof are omitted. The configuration of the communication device is of FIG. 6 is such that an input part 113 is added compared to the configuration of the communication device 1 of FIG. 2.

The input part 113 is an external interface capable of accepting a trigger input from a user using the communication device 1a. The input part 113 is, for example, a button. Besides the button, the input part may be any part as long as it allows the user to give a trigger input.

When the trigger input from the user is inputted via the input part 113, the beacon signal generator 109 makes the first sensing information obtained by measurement by the sensors 110 to 112 be included in the beacon signal for a certain period based on the trigger input.

Thus, based on the trigger input from the user via the input part 113 of the communication device 1a, the first sensing information is included in the beacon signal only for the certain period.

The beacon signal generator 109 does not allow the sensing information to be included in a beacon signal which passed a certain period or longer based on the trigger input. When newly connecting a node to a desired wireless network, the user can include biometric information in the beacon signal only for a certain period by giving the input trigger by using the input part 113. Thus, without always including the sensing information in the beacon signal, the user can include the sensing information in the beacon signal only for a certain period when new connection is necessary. Accordingly, notification by the beacon signal of sensing information more than necessary can be prevented. Consequently, the risk of leakage of sensing information, which is one of personal information, can be decreased.

### Second Embodiment

In the first embodiment, the communication device as a hub periodically transmits, by including in a beacon signal, sensing information obtained by a sensor which itself has. On the other hand, in a second embodiment, instead of including the sensing information obtained by a sensor which itself has in the beacon signal, sensing information transmitted from at least one of communication devices 2-2 to 2-7 as nodes, which are already connected to the wireless network formed by the own device, is included in the beacon signal. Thus, the communication device 1 as a hub in the second embodiment does not need sensors.

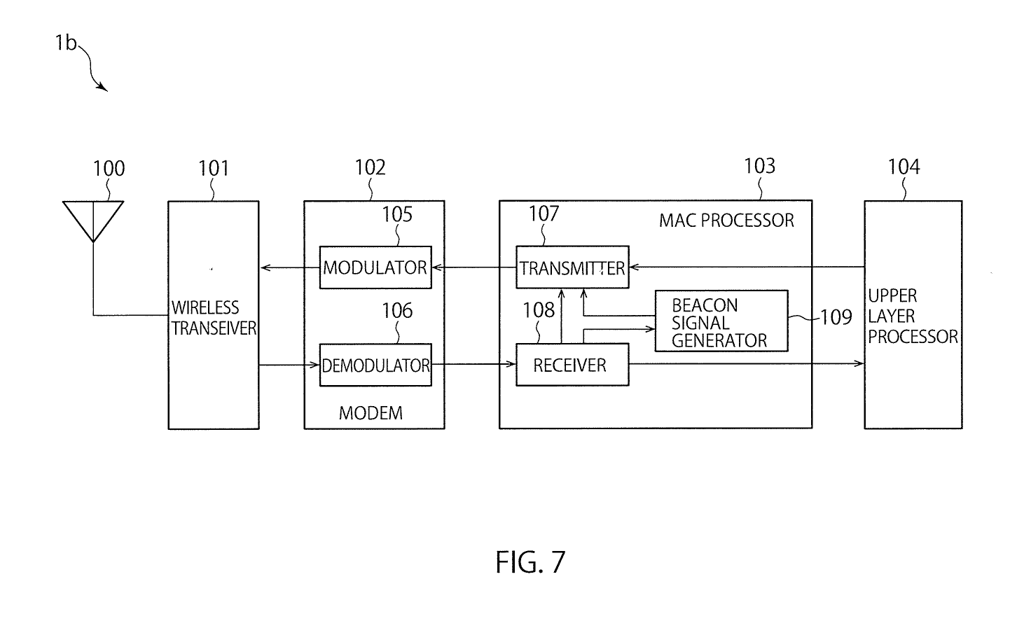

FIG. 7 is a diagram illustrating a configuration of a communication device 1b as a hub in the second embodiment. Note that common elements to those in FIG. 2 are given the same numerals, and specific explanations thereof are omitted. The configuration of the communication device 1b of FIG. 7 is a configuration in which the sensors 110 to 112 are deleted from the configuration of the communication device 1 of FIG. 2.

Upon receiving from a communication device as a connected node a frame including sensing information obtained by this node, the receiver 108 extracts the sensing information from the field including the sensing information in the received frame, and passes the extracted sensing information to the beacon signal generator 109.

The beacon signal generator 109 stores the sensing information obtained from the node in a not-illustrated buffer or the like as necessary, and thereafter includes the received sensing information in the periodically generated beacon signal. Then, a transmitter 308 wirelessly transmits this beacon signal by broadcast.

Here, the sensing information included by the beacon signal generator 109 in the beacon signal may be sensing information obtained by any one of communication devices as connected nodes, or may include biometrics information obtained from all wireless devices connected.

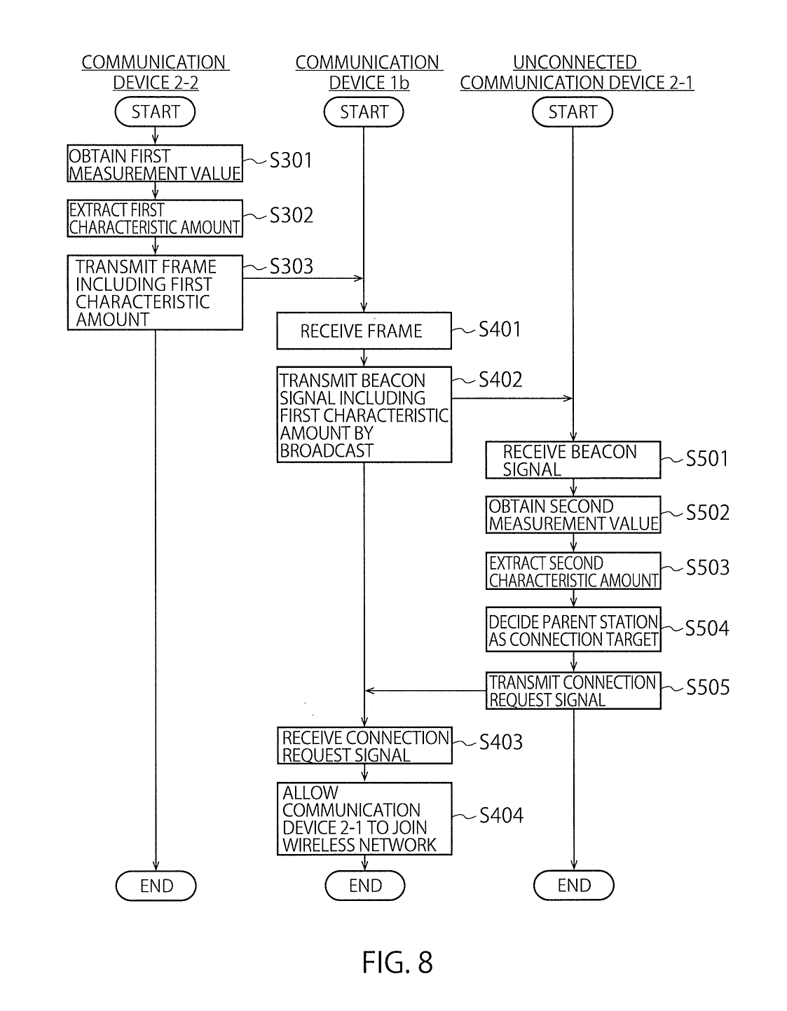

Operation of the communication device 1b having the above configuration, a communication device 2-1 not connected to the communication device 1b and a communication device 2-2 connected to the communication device 1b will be explained by using FIG. 8. FIG. 8 is a flowchart illustrating one example of processing of establishing connection in the second embodiment.

(Step S301) First, the transmitter 107 of the communication device 2-2 as a connected node obtains a first measurement value measured by the sensor 110 in the own device.

(Step S302) Next, the transmitter 107 of the communication device 2-2 extracts a first characteristic amount from the first measurement value obtained in step S301.

(Step S303) Next, the transmitter 107 of the communication device 2-2 transmits a frame including the first characteristic amount extracted in step S302.

(Step S401) Next, the receiver 108 of the communication device 1b as the hub receives the frame transmitted in step S303.

(Step S402) Next, the beacon signal generator 109 of the communication device 1b as the hub generates a beacon signal including the first characteristic amount included in the received frame. Then, the transmitter 107 wirelessly transmits the generated beacon signal by broadcast.

(Step S501) Next, the unconnected communication device 2-1 receives a plurality of beacon signals including the beacon signal transmitted in step S402.

(Step S502) Next, the determiner 114 of the communication device 2-1 obtains a second measurement value started to be measured by the sensor 110 in the own device.

(Step S503) Next, the determiner 114 of the communication device 2-1 extracts a second characteristic amount from the second measurement value obtained in step S502.

(Step S504) Next, the determiner 114 of the communication device 2-1 compares each of the first characteristic amounts included in the respective beacon signals with the second characteristic amount extracted in step S503. By comparing in this manner, the determiner 114 of the communication device 2-1 determines whether or not each of the first characteristic amounts included in the received beacon signal is a characteristic amount obtained from the same person on whom this communication device 2-1 is placed.

The determiner 114 of the communication device 2-1 decides as a hub as the connection target the communication device which has transmitted the beacon signal which includes the first characteristic amount determined as the characteristic amount obtained from the same person on whom this communication device 2 is placed as a result of determination. Here, as one example, the communication device 1b is decided as the hub as the connection target.

(Step S505) Then, the transmitter 107 of the communication device 2-1 transmits to this communication device 1b a connection request signal requesting for connection to the communication device 1b.

(Step S403) Next, the receiver 108 of the communication device 1b as the hub receives the connection request signal transmitted in step S505.

(Step S404) Next, the upper layer processor 104 or a not-illustrated management part in the MAC processor 103 of the communication device 1b as the hub executes processing for allowing the communication device 2-1 to join the wireless network.

As described above, in the second embodiment, the communication device (third communication device) 2-2 already connected to the wireless network formed by the communication device 1b includes the first sensor. Then, the first sensing information received by the receiver 108 of the communication device 2-1 is information obtained by the communication device 1b by communication from the communication device (third communication device) 2-2.

Thus, it becomes possible to include information obtained by sensors attached to various regions of a body in the beacon signal. Accordingly, the determiner 114 of the communication device 2-1 newly connecting to the hub, when determining whether or not it is sensing information obtained from the same person, can use sensing information which cannot be obtained in the region of the body where the hub is placed.

Therefore, as compared to the first embodiment, accuracy of determination by the determiner 114 can be increased. Further, it is not necessary to have sensors in the communication device 1b as the hub, and thus there is an advantage that it is less restricted by the region of the body where the communication device 1b as the hub is placed.

Further, in the second embodiment, in a state that none is connected to the communication device 1b as the hub, no transmission of sensing information to the communication device 1b is performed from any of the communication devices 2-2 to 2-7 as nodes, and thus the sensing information cannot be included in the beacon signal. Consequently, by this method, none can newly connect to the communication device 1b, and thus the communication device 1b as the hub and at least one or more nodes are preferred to be paired in an early stage by any kind of method.

### Third Embodiment

In the first and second embodiments, the communication device as a hub includes sensing information itself which can identify an individual in a beacon signal. On the other hand, in a third embodiment, instead of including the sensing information directly in the beacon signal, information in which the sensing information is hashed is included in the beacon signal.

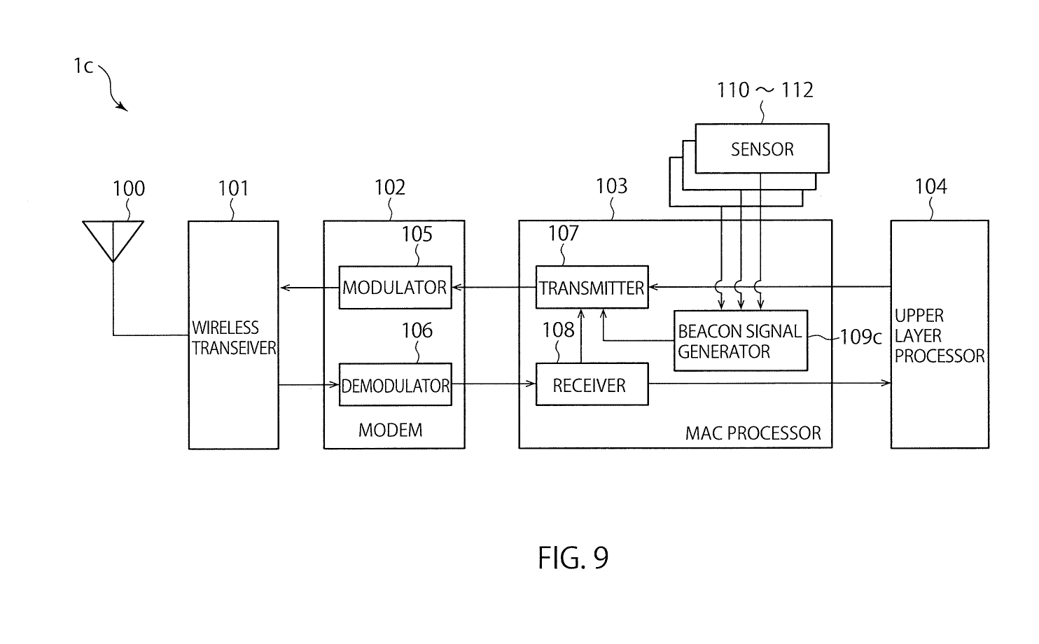

FIG. 9 is a diagram illustrating a configuration of a communication device is as a hub in the third embodiment. Note that common elements to those in FIG. 2 are given the same numerals, and specific explanations thereof are omitted. The configuration of the communication device 1c of FIG. 9 is such that the beacon signal generator 109 is changed to a beacon signal generator 109c in the configuration of the communication device 1 of FIG. 2.

The beacon signal generator 109c performs hashing with either sensing information obtained by a sensor included in the own device or sensing information obtained and transmitted by the communication devices 2-2 to 2-7 as already connected nodes being an input value. A hash function used for hashing may be any function.

The beacon signal generator 109c generates a beacon signal including a hash value obtained after the hashing, and wirelessly transmits the generated beacon signal periodically by broadcast.

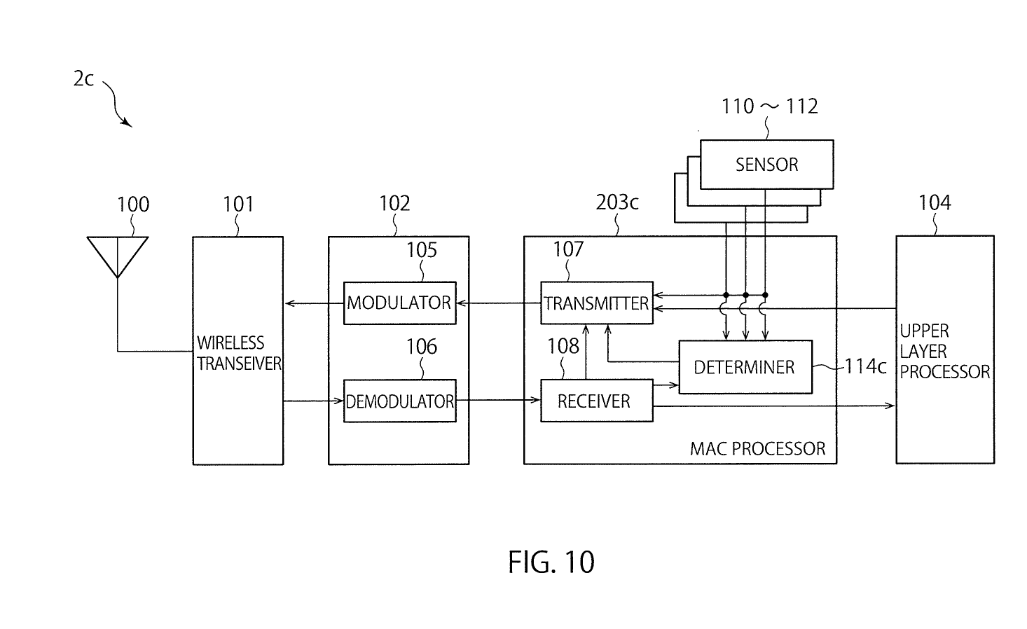

On the other hand, a configuration of a communication device 2c newly joining to the wireless network formed by the communication device 1c will be explained by using FIG. 10. FIG. 10 is a diagram illustrating the configuration of the communication device 2c as a node in the third embodiment. Note that common elements to those in FIG. 3 are given the same numerals, and specific explanations thereof are omitted. The configuration of the communication device 2c of FIG. 10 is such that the determiner 114 is changed to a determiner 114c in the configuration of the communication device 2 of FIG. 3. Accompanying this, the MAC processor 203 is changed to a MAC processor 203c.

The determiner 114c obtains measurement values measured by the sensors 110 to 112 in the region of the body where the own device is placed. At the same time, the determiner 114c obtains a second hash value by hashing with the obtained measurement values or characteristic amounts extracted from the measurement values being input values. Here, the hash function to be used is the same as the hash function used by the communication device is forming the wireless network.

Then, the determiner 114c refers to a field including a first hash value in each beacon signal received by scanning, and compares each first hash value with the second hash value. That is, the determiner 114c compares hash values with each other. Thus, the determiner 114c determines whether or not each of received first hash values is a hash value obtained based on measurement values obtained from the same person as one having the own device.

As long as hash values are ones obtained with measurement values of the same type (for example, pulse waves) obtained from the same person or characteristic amounts extracted from the measurement values of the same type being input values, bit series of hash values coincide with each other.

For example, when a peak interval of pulse waves is used as a characteristic amount, if the peak interval of pulse waves is hashed by a four-bit bit sequence, the determiner 114c may determine a received hash value as a hash value obtained based on measurement values obtained from the same person as one having the own device if the four-bit bit sequence coincides.

Alternatively, a case is assumed where measurement values of the same type or hash values extracted from the measurement values of the same type are not used as input values of the hash function in the communication device 1c and the communication device 2c. In this case, the determiner 114c determines whether or not each received hash value is a hash value obtained based on the measurement values obtained from the same person as one having the own device by using the correlation of measurement values of sensors with each other.

Specifically, a case is assumed where, for example, the first sensor of the hub measures a heart rate, and a second sensor of the node measures pulse waves. Then, it is assumed that a not-illustrated memory included in the determiner 114c stores a table in which, when a hash value of the peak interval of a heart rate is given, one or more candidates for a hash value of the peak interval of corresponding pulse waves are associated therewith. On this assumption, the determiner 114c searches for a hash value of the peak interval of the same heart rate as the hash value in the beacon signal in this table. Then, the determiner 114c determines whether or not there is a hash value of the peak interval of pulse waves measured in the own device among the candidates for a hash value of the peak interval of the pulse waves corresponding to the hash value of the peak interval of the heart rate found as a result of searching. As a result of this determination, when there is a hash value of the peak interval of the pulse waves measured in the own device, the determiner 114c determines that the hash value in this beacon signal is a hash value obtained based on the sensing information obtained from the same person as one having the own device. The above-described memory may either be a volatile memory such as a DRAM or the like or a non-volatile memory such as a NAND, an MRAM or the like. Alternatively, instead of the memory a storage medium such as a hard disk or an SSD may be used.

Then, the transmitter 107 transmits a connection request signal (for example, a connection request frame) to a communication device as a hub which transmitted the beacon signal including the hash value obtained based on biometrics information obtained from the same person as one having the own device by determination.

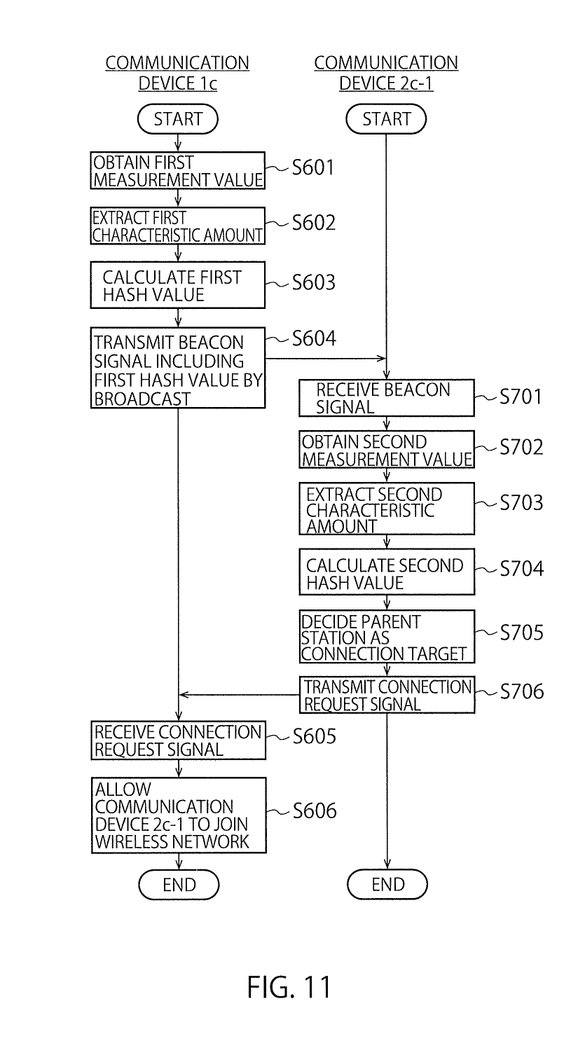

Next, assuming a case where a communication device 2c-1 newly joins a wireless network formed by the communication device is as the hub, processing of establishing connection will be explained by using FIG. 11. FIG. 11 is a flowchart illustrating one example of processing of establishing connection in the third embodiment. Note that communication devices 2c-2, . . . , 2c-7 as other nodes are, as one example, already connected to the communication device 1c as a hub.

Processing of steps S601 and S602 is the same as the processing of steps S101 and S102 of FIG. 4, and thus explanations thereof are omitted.

(Step S603) Next, the beacon signal generator 109c of the communication device is calculates a first hash value obtained by hashing a first characteristic amount.

(Step S604) Next, the transmitter 107 of the communication device 1c wirelessly transmits a beacon signal including the first hash value by broadcast.

Processing of steps S701 to S703 is the same as the processing of steps S201 to S203 of FIG. 4, and thus explanations thereof are omitted.

(Step S704) Next, the determiner 114c of the communication device 2c-1 calculates a second hash value obtained by hashing a second characteristic amount.

(Step S705) Next, the determiner 114c of the communication device 2c-1 compares each of first hash values included in beacon signals received from a plurality of communication devices with the second hash value. Then, the determiner 114c of the communication device 2c-1 determines whether or not each of the first hash values is a hash value obtained based on measurement values obtained from the same person as the person on whom the own device is placed.

The determiner 114c of the communication device 2c-1 decides as the hub as the connection target the communication device which transmitted the beacon signal including the first hash value determined as the hash value obtained based on the measurement values obtained from the same person as the person on whom the communication device 2c-1 is placed as a result of determination. Here, as one example, the communication device 1c is decided as the hub as the connection target.

(Step S706) Then, the transmitter 107 of the communication device 2c-1 transmits to the communication device 1c a connection request signal which requests for connection to the communication device 1c.

(Step S605) Next, the receiver 108 of the communication device 1c receives the connection request signal transmitted in step S706.

(Step S606) Next, the upper layer processor 104 or a not-illustrated management part in the MAC processor 103 of the communication device is executes processing for allowing the communication device 2c-1 to join the wireless network.

As described above, in the third embodiment, the first sensing information is the first hash value obtained by hashing measurement values of the first sensor of the communication device is or the first characteristic amount extracted from the measurement values of the first sensor. The determiner 114c of the communication device 2c calculates as the second sensing information the second hash value obtained by hashing measurement values of the second sensor of the own device or the second characteristic amount extracted from the measurement values of the second sensor. Then, the determiner 114c compares the first hash value with the second hash value so as to determine whether or not each of the first hash values is a hash value obtained based on measurement values obtained from the same person as the person on whom the own device is placed.

Thus, the information included in the beacon signal is not the information itself as the measurement values of the first sensor or the first characteristic amount but is a hash value. Here, the hash value is merely a random bit series, and the hashed information cannot be restored to the original information. Thus, even if a third person receives and analyzes the beacon signal, since it cannot be restored to the original information, leakage of the original information to the third person can be prevented.

### Fourth Embodiment

In the first to third embodiments, as a method for newly connecting to a wireless network formed by a communication device as a hub, the method by passive scanning is explained, which is to detect a wireless network existing in surroundings by passively receiving for a certain period of time beacon signals transmitted periodically by communication devices of respective hubs. On the other hand, in a fourth embodiment, a method by active scanning will be explained.

In the fourth embodiment, a communication device 2d-1 newly joining to a wireless network formed by a communication device 1d starts obtaining biometrics information by using sensors of the own device in the region of the body where it is placed. At the same time, the communication device 2d-1 includes sensing information obtained by measurement by the sensors of the own device in a probe request signal and wirelessly transmits the probe request signal by broadcast. This probe request signal is a signal requesting for a response to a hub placed on the same object (here, as one example, a person) as one having the own device.

Communication devices as hubs existing in surroundings receive the probe request signal transmitted by the communication device 2d-1. The communication device as each hub, upon receiving the probe request signal, refers to a field including sensing information in the probe request signal, and compares the sensing information with sensing information obtained by the sensors included in each hub. When the sensing information in the probe request signal is determined as sensing information obtained from the same person as a result of comparison, the hub returns a probe response signal to the communication device 2d as a response to the probe request signal. This probe response signal is a signal responding to the probe request signal.

On the other hand, when it is determined that the sensing information is not the sensing information obtained from the same person, the hub gives no response. That is, the communication device as the hub returns the probe response signal only upon receiving the probe request signal including sensing information which coincided with the sensing information obtained by the own sensor.

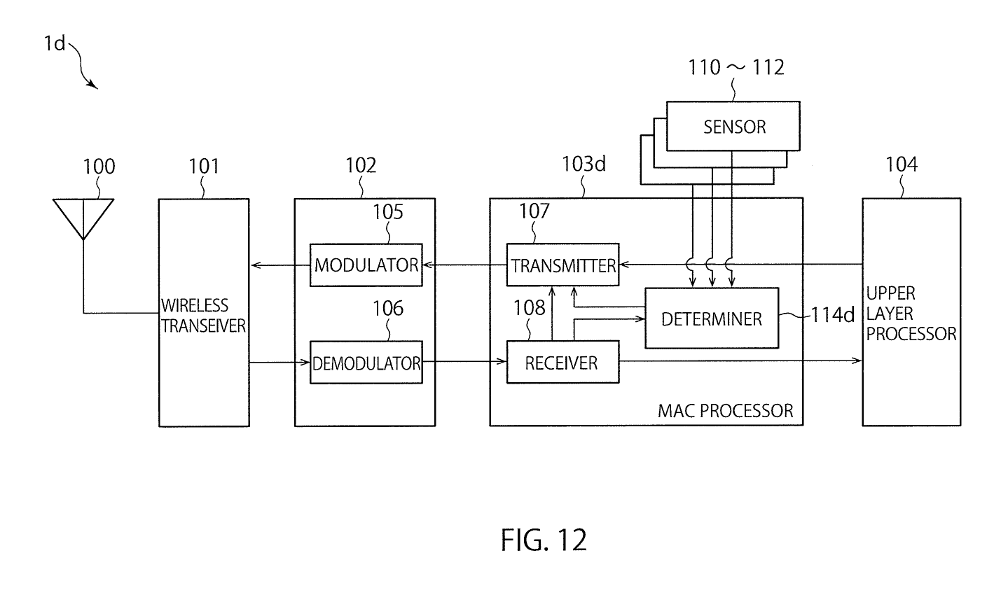

FIG. 12 is a diagram illustrating a configuration of the communication device 1d as a hub in the fourth embodiment. Note that common elements to those in FIG. 2 are given the same numerals, and specific explanations thereof are omitted. The configuration of the communication device 1d of FIG. 12 is such that the beacon signal generator 109 is deleted and a determiner 114d is added in the configuration of the communication device 1 of FIG. 2. Accompanying this, the MAC processor 103 is changed to a MAC processor 103d.

The receiver 108 receives the probe request signal transmitted by the communication device 2d-1.

When the receiver 108 receives the probe request signal as described above, the determiner 114d refers to the field including sensing information in the probe request signal, and compares the sensing information with sensing information obtained by the sensors included in each hub.

When the determiner 114d determines, as a result of comparison, that the sensing information in the probe request signal is sensing information obtained from the same person, the transmitter 107 returns the probe response signal to the communication device 2d as a response to the probe request signal. On the other hand, when the determiner 114d determines that it is not sensing information obtained from the same person, the transmitter 107 gives no response.

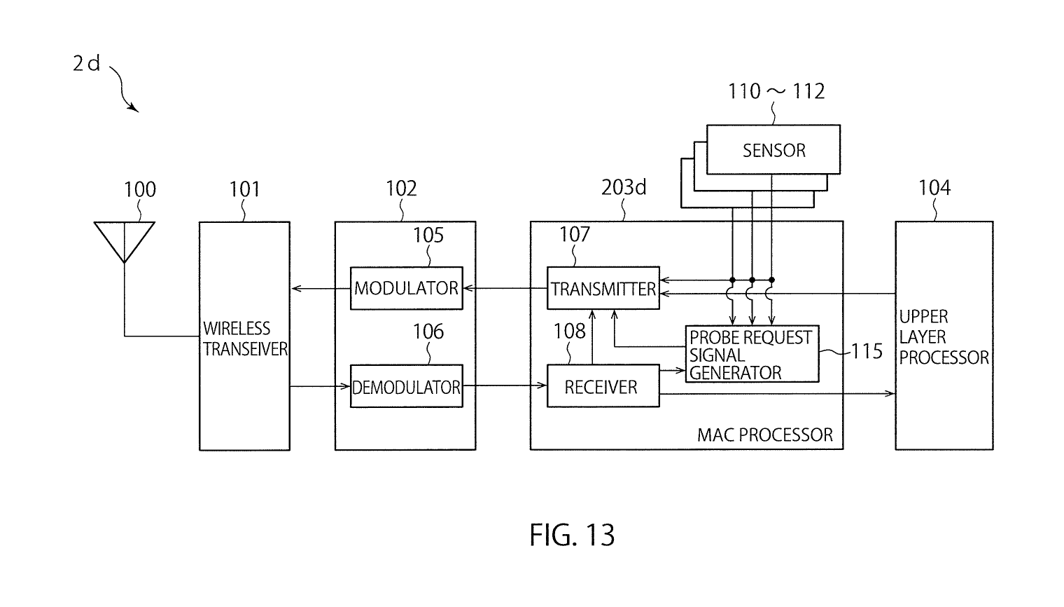

FIG. 13 is a diagram illustrating a configuration of the communication device 2d as a node in the fourth embodiment. Note that common elements to those in FIG. 3 are given the same numerals, and specific explanations thereof are omitted. The configuration of the communication device 2d of FIG. 13 is such that the determiner 114 is deleted and a probe request signal generator 115 is added in the configuration of the communication device 2 of FIG. 3. Accompanying this, the MAC processor 203 is changed to a MAC processor 203d.

The probe request signal generator 115 generates the probe request signal including sensing information obtained by measurement by the sensors 110 to 112 of the own device.

The transmitter 107 wirelessly transmits the generated probe request signal by broadcast.

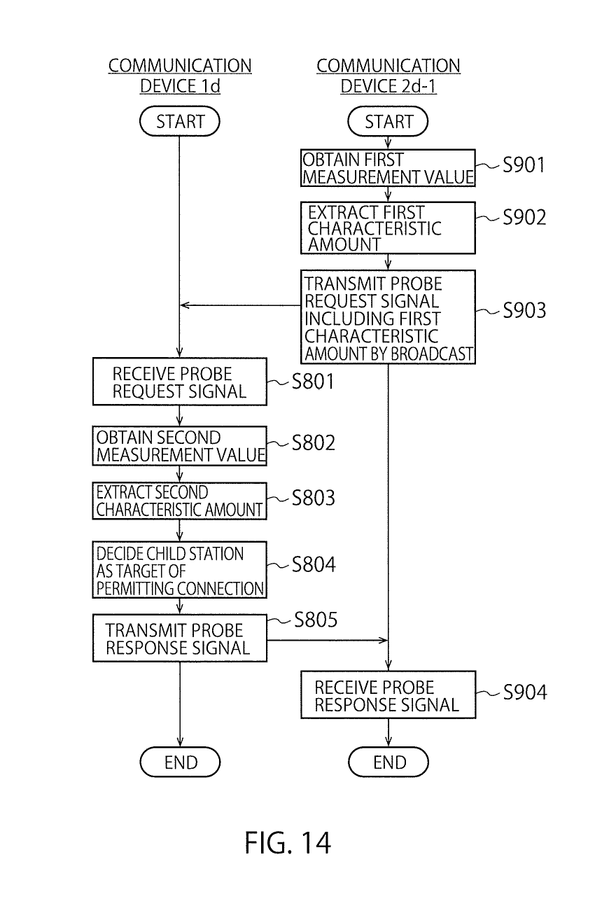

Subsequently, assuming a case that the communication device 2d-1 newly joins the wireless network formed by the communication device 1d as the hub, processing of establishing connection will be explained by using FIG. 14. FIG. 14 is a flowchart illustrating one example of processing of establishing connection in the fourth embodiment. Note that the communication devices 2d-2, . . . , 2d-7 as other nodes are, as one example, already connected to the communication device 1d as the hub.

(Step S901) First, the probe request signal generator 115 of the communication device 2d-1 obtains a first measurement value measured by the sensor 110 in the own device.

(Step S902) Next, the probe request signal generator 115 of the communication device 2d-1 extracts a first characteristic amount from the first measurement value obtained in step S901.

(Step S903) Next, the transmitter 107 of the communication device 2d-1 wirelessly transmits the probe request signal including the first characteristic amount periodically by broadcast.

Thus, the communication device 2d-1 which desires connection includes sensing information obtained by measurement by the sensor included in itself in the probe request signal and transmits the probe request signal periodically.

(Step S801) Next, the receiver 108 of the communication device 1d receives a plurality of probe request signals including the probe request signal transmitted in step S903.

(Step S802) Next, the determiner 114d of the communication device 1d obtains a second measurement value started to be measured by the sensor 110 in the own device.

(Step S803) Next, the determiner 114d of the communication device 1d extracts a second characteristic amount from the second measurement value obtained in step S802.

(Step S804) Next, the determiner 114d of the communication device 1d compares each of the first characteristic amounts included in the respective probe request signals with the second characteristic amount extracted in step S803. At this time, ones to be compared need not be one and another characteristic amount but may be one and another plurality of characteristic amounts.

By comparing in this manner, the determiner 114d of the communication device 1d determines whether or not sensing information obtained from the same person on whom this communication device 1d is placed is included in each of the probe request signals received.

The determiner 114d of the communication device 1d decides as a node as the target of permitting connection the communication device which has transmitted the probe request signal determined to include the sensing information obtained from the same person on whom this communication device 1d is placed as a result of determination. Here, as one example, the communication device 2d-1 is decided as the node as the target of permitting connection.

(Step S805) Then, the transmitter 107 of the communication device 1d wirelessly transmits the probe response signal to permit connection to the node decided in step S805, namely, the communication device 2d-1.

(Step S904) Next, the transmitter 107 of the communication device 2d-1 receives the probe response signal wirelessly transmitted in step S806.

As described above, in the communication device 1d according to the fourth embodiment, the receiver 108 receives a transmitted signal including the first sensing information obtained by measurement by the first sensor from the communication device 2d-1 as another communication device.

The determiner 114d compares the first sensing information included in the received transmitted signal with the second sensing information obtained by measurement by the second sensor, so as to determine whether or not the first sensing information and the second sensing information are obtained from the same target object.

When it is determined that the information is obtained from the same target object, the transmitter 107 transmits to the communication device 2d-1 as another communication device a wireless connection signal (here, as one example, the probe response signal) for allowing connection of the communication device 2d-1 as another communication device to the wireless network.

Thus, the communication device 2d-1 receives the probe response signal only from the communication device 1d forming the wireless network placed on the same person as the person on whom the own device is placed. Accordingly, the communication device 2d-1 can select the communication device 1d as a hub without selecting as the hub the communication device placed on a person different from the person on whom the own device is placed. Consequently, the communication device 2d-1 can securely connect to the communication device 1d placed on the same person as the person on whom the own device is placed.

### Fifth Embodiment

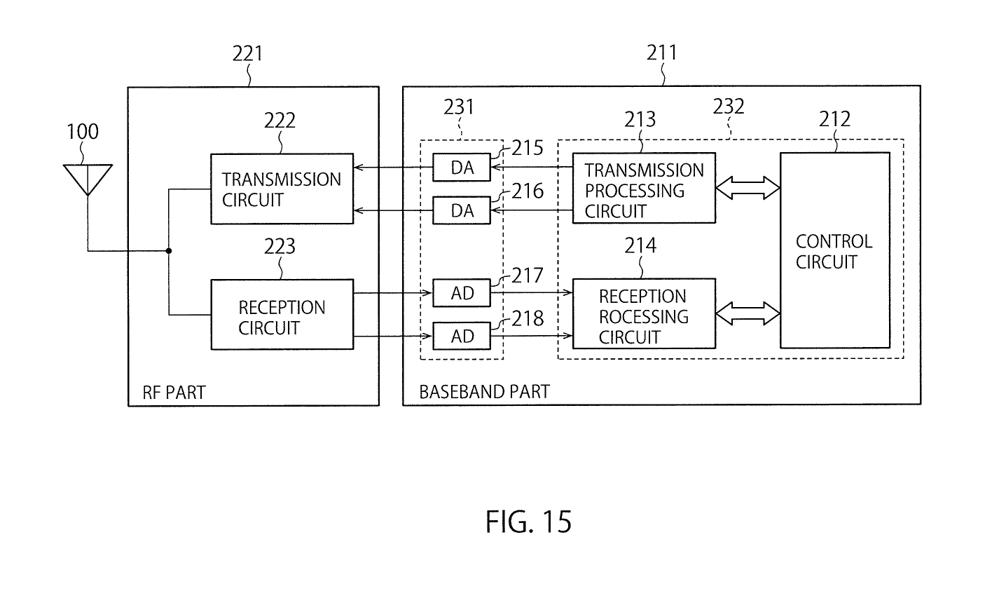

Next, a fifth embodiment will be explained. In the fifth embodiment, hardware configuration examples of the communication device 1 and the communication device 2 of the first embodiment will be explained. First, the hardware configuration example of the communication device 1 of the first embodiment will be explained by using FIG. 15.

(Hardware Configuration Example of the Communication Device 1)

FIG. 15 is a diagram illustrating the hardware configuration example of the communication device 1 according to the first embodiment. This hardware configuration is one example and the hardware configuration can be changed in various ways. Operation of the communication device illustrated in FIG. 15 is similar to that of the communication device as the hub as has been explained with FIG. 2. Thus, differences in hardware configuration will be mainly explained below, and detailed explanations of operation will be omitted.

This communication device has a baseband part 211, an RF part 221, and at least one antenna 100.

The baseband part 211 includes a control circuit 212, a transmission processing circuit 213, a reception processing circuit 214, DA conversion circuits 215, 216, and AD conversion circuits 217, 218. The RF part 221 and the baseband part 211 may be configured together as a one-chip IC (Integrated Circuit), or may be configured as separate chips.

As one example, the baseband part 211 is a baseband LSI or a baseband IC or both of them. Alternatively, the baseband part 211 may have an IC 232 and an IC 231 as indicated by dotted frames illustrated. Here, the components may be separated in respective ICs such that the IC 232 includes the control circuit 212, the transmission processing circuit 213, and the reception processing circuit 214, and the IC 231 includes the DA conversion circuits 215, 216 and the AD conversion circuits 217, 218. The IC 232 includes both the mode of one-chip IC and the mode constituted of a plurality of chip ICs.

The control circuit 212 mainly executes the function of the MAC processor 103 illustrated in FIG. 2. The function of the upper layer processor 104 may be included in the control circuit 212. The control circuit 212 or the IC 232 corresponds to, as one example, a communication processing device controlling communication or a controller controlling communication. At this time, a wireless communication part according to this embodiment may include a transmission circuit 222 and a reception circuit 223. The wireless communication part may include DA conversion circuits 215, 216 and AD conversion circuits 217, 218, in addition to the transmission circuit 222 and the reception circuit 223. The wireless communication part may include the transmission processing circuit 213 and the reception processing circuit 214 in addition to the transmission circuit 222 and the reception circuit 223, the DA conversion circuits 215, 216, and the AD conversion circuits 217, 218. An integrated circuit according to this embodiment may have a processor which performs the entire or part of processing of the baseband part 211, that is, the entire or part of processing of the control circuit 212, the transmission processing circuit 213, the reception processing circuit 214, the DA conversion circuits 215, 216, and the AD conversion circuits 217, 218.

The transmission processing circuit 213 corresponds to a part performing processing of the physical layer of the modulator 105 illustrated in FIG. 2. That is, the transmission processing circuit 213 performs processing such as adding a preamble and a physical header, encoding, modulating, and the like, so as to generate, for example, two kinds of digital baseband signals (hereinafter, a digital I signal and a digital Q signal). In the case of transmission of the MIMO, two kinds of digital baseband signals are generated according to respective streams.

The reception processing circuit 214 corresponds to a part performing reception processing of the physical layer of the demodulator 106 illustrated in FIG. 2. That is, the reception processing circuit 214 performs processing of demodulation, decoding, analyzing a preamble and a physical header, and so on.

Note that there is another possible configuration in which the function of the transmitter 107 of FIG. 2 is included in the transmission processing circuit 213, the function of the receiver 108 is included in the reception processing circuit 214, and the function of the beacon signal generator 109 is included in the control circuit 212.

The DA conversion circuits 215, 216 are equivalent to a part performing DA conversion of the modulator 105 illustrated in FIG. 2. The DA conversion circuits 215, 216 DA-convert a signal inputted from the transmission processing circuit 213. More specifically, the DA conversion circuit 215 converts a digital I signal into an analog I signal, and the DA conversion circuit 216 converts a digital Q signal into an analog Q signal. Note that there may also be a case where a signal of one system is transmitted as it is without performing quadrature modulation. In this case, only one DA conversion circuit is necessary. Further, when a transmitted signal or signals of one system or plural systems are transmitted in a distributed manner by the number of antennas, a number of DA conversion circuits according to the number of antennas may be provided.

The RF part 221 is, as one example, an RF analog IC or a high-frequency IC. The transmission circuit 222 in the RF part 221 is equivalent to a part which performs analog processing at a time of transmission in a later stage than the DA conversion in the modulator 105 illustrated in FIG. 2, and a part which performs analog processing at a time of transmission in the wireless transceiver 101. The transmission circuit 222 includes a transmission filter which extracts a signal of a desired band from signals of frames which are DA-converted by the DA conversion circuits 215, 216, a mixer which up-converts a signal after filtering to a radio frequency by using the signal of a certain frequency supplied from an oscillation device, a preamplifier (PA) which amplifies a signal after up-conversion, and so on.

The reception circuit 223 in the RF part 221 is equivalent to a part performing analog processing at a time of reception in the wireless transceiver 101 illustrated in FIG. 2, and a part performing analog processing at a time of reception up to a preceding stage of the AD conversion in the demodulator 106. The reception circuit 223 includes an LNA (low-noise amplifier) amplifying a signal received by the antenna 100, a mixer down-converting a signal after amplification into the baseband by using a signal of a certain frequency supplied from an oscillation device, a reception filter extracting a signal in a desired band from a signal after down-conversion, and so on. More specifically, the reception circuit 223 quadrature-demodulates a received signal which is low-noise-amplified in a not-illustrated low-noise amplifier by carrier waves which are shifted in phase by 90° from each other, so as to generate an I (In-phase) signal in phase with the received signal and a Q (Quad-phase) signal whose phase is delayed by 90° therefrom. These I signal and Q signal are outputted from a reception circuit 223 after its gain is adjusted.

The control circuit 212 may control operation of the transmission filter of the transmission circuit 222 and the reception filter of the reception circuit 223 according to setting of the channel used. There may exist another controller controlling the transmission circuit 222 and the reception circuit 223, and the control circuit 212 may instruct this controller to perform similar processing.

The AD conversion circuits 217, 218 in the baseband part 211 are equivalent to a part performing AD conversion of the demodulator 106 illustrated in FIG. 2. The AD conversion circuits 217, 218 AD-convert an input signal from the reception circuit 223. More specifically, the AD conversion circuit 217 converts an I signal into a digital I signal, and the AD conversion circuit 218 converts a Q signal into a digital Q signal. Note that there may also be a case of receiving only a signal of one system without performing quadrature demodulation. In this case, only one AD conversion circuit is necessary. Further, when a plurality of antennas are provided, a number of AD conversion circuits according to the number of antennas may be provided.

Note that a switch for switching the antenna 100 to one of the transmission circuit 222 and the reception circuit 223 may be disposed in the RF part. By controlling this switch, the antenna 100 may be connected to the transmission circuit 222 at a time of transmission, and the antenna 100 may be connected to the reception circuit 223 at a time of reception.

In FIG. 15, the DA conversion circuits 215, 216 and the AD conversion circuits 217, 218 are disposed on the baseband part 211 side, but the conversion circuits may be configured to be disposed on the RF part 221 side.

The configuration example of FIG. 15 is one example, and this embodiment is not limited to this.

The MAC processor 103 controlling communication corresponds to, as one example, the control circuit 212 but is not limited to this. The MAC processor 103 may further include the transmission processing circuit 213 and the reception processing circuit 214 in addition to the control circuit 212. Further, the MAC processor 103 may include the DA conversion circuits 215, 216 and the AD conversion circuits 217, 218 in addition to the transmission processing circuit 213 and the reception processing circuit 214. Moreover, the MAC processor 103 may include the transmission circuit 222 and the reception circuit 223 in addition to the transmission processing circuit 213, the reception processing circuit 214, the DA conversion circuits 215, 216, and the AD conversion circuits 217, 218.

Alternatively, the IC 232 may correspond to the MAC processor 103 and the modem 106 controlling communication. At this time, the wireless transceiver 101 may include the transmission circuit 222 and the reception circuit 223. Moreover, the wireless transceiver 101 may include the DA conversion circuits 215, 216 and the AD conversion circuits 217, 218 in addition to the transmission circuit 222 and the reception circuit 223.

(Hardware Configuration Example of the Communication Device 2)

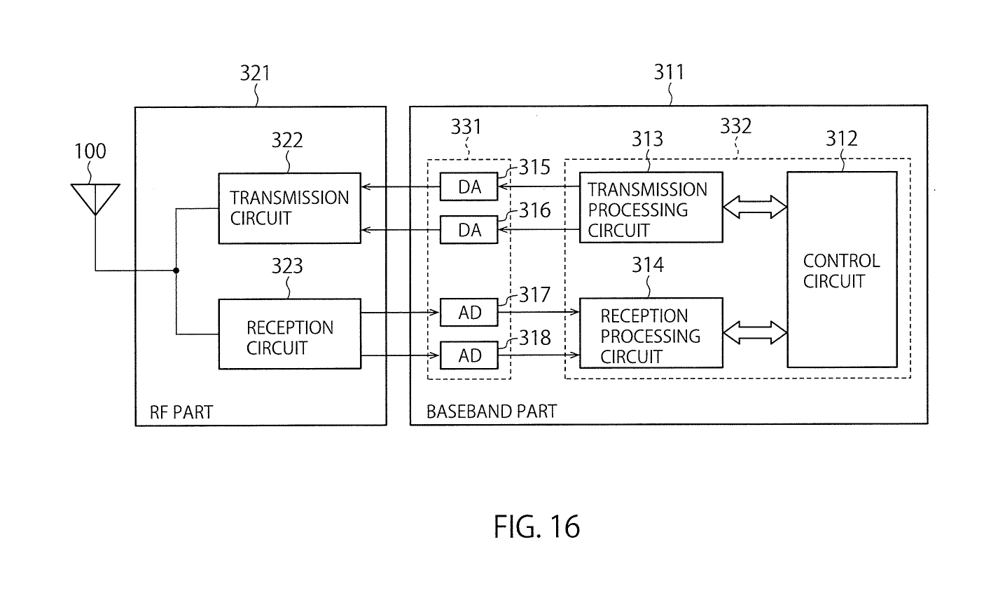

Next, the hardware configuration example of the communication device 2 according to the first embodiment will be explained by using FIG. 16. FIG. 16 is a diagram illustrating the hardware configuration example of the communication device 2 according to the first embodiment.

FIG. 16 illustrates the hardware configuration example of the communication device 2 according to the first embodiment.

This hardware configuration example is one example and the hardware configuration can be changed in various ways. Operation of the communication device illustrated in FIG. 16 is similar to that of the communication device as has been explained with FIG. 3. Thus, differences in hardware configuration will be mainly explained below, and detailed explanations of operation will be omitted.

This communication device has a baseband part 311, an RF part 321, and at least one antenna 100.

The baseband part 311 includes a control circuit 312, a transmission processing circuit 313, a reception processing circuit 314, DA conversion circuits 315, 316, and AD conversion circuits 317, 318. The RF part 321 and the baseband part 311 may be configured together as a one-chip IC (Integrated Circuit), or may be configured as separate chips.

As one example, the baseband part 311 is a baseband LSI or a baseband IC or both of them. Alternatively, the baseband part 311 may have an IC 332 and an IC 331 as indicated by dotted frames illustrated. Here, the components may be separated in respective ICs such that the IC 332 includes the control circuit 312, the transmission processing circuit 313, and the reception processing circuit 314, and the IC 331 includes the DA conversion circuits 315, 316 and the AD conversion circuits 317, 318. The IC 332 includes both the mode of one-chip IC and the mode constituted of a plurality of chip ICs.

The control circuit 312 executes the function of the MAC processor 203 illustrated in FIG. 3. The function of the upper layer processor 104 may be included in the control circuit 312.

The control circuit 312 or the IC 332 corresponds to, as one example, a communication processing device controlling communication or a controller controlling communication. At this time, a wireless communication part according to this embodiment may include a transmission circuit 322 and a reception circuit 323. The wireless communication part may include DA conversion circuits 315, 316 and AD conversion circuits 317, 318, in addition to the transmission circuit 322 and the reception circuit 323. Moreover, the wireless communication part may include the transmission processing circuit 313 and the reception processing circuit 314 in addition to the transmission circuit 322 and the reception circuit 323, the DA conversion circuits 315, 316, and the AD conversion circuits 317, 318. An integrated circuit according to this embodiment may have a processor which performs the entire or part of processing of the baseband part 311, that is, the entire or part of processing of the control circuit 312, the transmission processing circuit 313, the reception processing circuit 314, the DA conversion circuits 315, 316, and the AD conversion circuits 317, 318.

The transmission processing circuit 313 corresponds to a part performing processing of the physical layer of the modulator 105 illustrated in FIG. 3. That is, the transmission processing circuit 313 performs processing such as adding a preamble and a physical header, encoding, modulating, and the like, so as to generate, for example, two kinds of digital baseband signals (hereinafter, a digital I signal and a digital Q signal). In the case of transmission of the MIMO, two kinds of digital baseband signals are generated according to respective streams.

The reception processing circuit 314 corresponds to a part performing reception processing of the physical layer of the demodulator 106 illustrated in FIG. 3. That is, the reception processing circuit 314 performs processing of demodulation, decoding, analyzing a preamble and a physical header, and so on.

Note that there is another possible configuration in which the function of the transmitter 107 of FIG. 3 is included in the transmission processing circuit 313, the function of the receiver 108 is included in the reception processing circuit 314, and the function of the determiner 114 is included in the control circuit 312.

The DA conversion circuits 315, 316 are equivalent to a part performing DA conversion of the modulator 105 illustrated in FIG. 3. The DA conversion circuits 315, 316 DA-convert a signal inputted from the transmission processing circuit 313. More specifically, the DA conversion circuit 315 converts a digital I signal into an analog I signal, and the DA conversion circuit 316 converts a digital Q signal into an analog Q signal. Note that there may also be a case where a signal of one system is transmitted as it is without performing quadrature modulation. In this case, only one DA conversion circuit is necessary. Further, when a transmitted signal or signals of one system or plural systems are transmitted in a distributed manner by the number of antennas, a number of DA conversion circuits according to the number of antennas may be provided.

The RF part 321 is, as one example, an RF analog IC or a high-frequency IC. The transmission circuit 322 in the RF part 321 is equivalent to a part which performs analog processing at a time of transmission in a later stage than the DA conversion in the modulator 105 illustrated in FIG. 3, and a part which performs analog processing at a time of transmission in the wireless transceiver 101. The transmission circuit 322 includes a transmission filter which extracts a signal of a desired band from signals of frames which are DA-converted by the DA conversion circuits 315, 316, a mixer which up-converts a signal after filtering to a radio frequency by using the signal of a certain frequency supplied from an oscillation device, a preamplifier (PA) which amplifies a signal after up-conversion, and so on.

The reception circuit 323 in the RF part 321 is equivalent to a part performing analog processing at a time of reception in the wireless transceiver 101 illustrated in FIG. 3, and a part performing analog processing at a time of reception up to a preceding stage of the AD conversion in the demodulator 106. The reception circuit 323 includes an SNA (low-noise amplifier) amplifying a signal received by the antenna, a mixer down-converting a signal after amplification into the baseband by using a signal of a certain frequency supplied from an oscillation device, a reception filter extracting a signal in a desired band from a signal after down-conversion, and so on. More specifically, the reception circuit 323 quadrature-demodulates a received signal which is low-noise-amplified in a not-illustrated low-noise amplifier by carrier waves which are shifted in phase by 90° from each other, so as to generate an I (In-phase) signal in phase with the received signal and a Q (Quad-phase) signal whose phase is delayed by 90° therefrom. These I signal and Q signal are outputted from the reception circuit 323 after its gain is adjusted.

The control circuit 312 may control operation of the transmission filter of the transmission circuit 322 and the reception filter of the reception circuit 323 according to setting of the channel used. There may exist another controller controlling the transmission circuit 322 and the reception circuit 323, and the control circuit 312 may instruct this controller to perform similar processing.

The AD conversion circuits 317, 318 in the baseband part 311 are equivalent to a part performing AD conversion of the demodulator 106 illustrated in FIG. 3. The AD conversion circuits 317, 318 AD-convert an input signal from the reception circuit 323. More specifically, the AD conversion circuit 317 converts an I signal into a digital I signal, and the AD conversion circuit 318 converts a Q signal into a digital Q signal. Note that there may also be a case of receiving only a signal of one system without performing quadrature demodulation. In this case, only one AD conversion circuit is necessary. Further, when a plurality of antennas are provided, a number of AD conversion circuits according to the number of antennas may be provided.

Note that a switch for switching the antenna 100 to one of the transmission circuit 322 and the reception circuit 323 may be disposed in the RF part. By controlling this switch, the antenna 100 may be connected to the transmission circuit 322 at a time of transmission, and the antenna 100 may be connected to the reception circuit 323 at a time of reception.

In FIG. 16, the DA conversion circuits 315, 316 and the AD conversion circuits 317, 318 are disposed on the baseband part 311 side, but the conversion circuits may be configured to be disposed on the RF part 321 side.

The configuration example of FIG. 16 is one example, and this embodiment is not limited to this.

The MAC processor 203 controlling communication corresponds to, as one example, the control circuit 312 but is not limited to this. The MAC processor 203 may further include the transmission processing circuit 313 and the reception processing circuit 314 in addition to the control circuit 312. Further, the MAC processor 203 may include the DA 315, 316 and the AD 317, 318 in addition to the transmission processing circuit 313 and the reception processing circuit 314. Moreover, the MAC processor 203 may include the transmission circuit 322 and the reception circuit 323 in addition to the transmission processing circuit 313, the reception processing circuit 314, the DA 315, 316, and the AD 317, 318.

Alternatively, the IC 332 may correspond to the MAC processor 203 and the modem 106 controlling communication. At this time, the wireless transceiver 101 may include the transmission circuit 222 and the reception circuit 223. Moreover, the wireless transceiver 101 may include the DA conversion circuits 215, 216 and the AD conversion circuits 217, 218 in addition to the transmission circuit 222 and the reception circuit 223.

### Modification Example

When a plurality of sensors are mounted in a hub, the type of biometrics information (for example, pulse wave) transmitted from a hub and the type of a characteristic amount thereof (for example, peak interval) may be determined in advance.

On the other hand, the hub may select and transmit the type of biometrics information (for example, pulse wave) and the type of a characteristic amount thereof (for example, peak interval). In this case, information indicating the type of a sensor (pulse wave sensor) by which the characteristic amount is obtained or the type of biometrics information (for example, pulse wave) and information indicating the type of the characteristic amount (for example, peak interval) are included together in the beacon signal.

The beacon signal generator 109 may generate a beacon signal including, in addition to first sensing information, the type of a sensor by which the first sensing information is obtained. Thus, the transmitted signal further includes, in addition to the first sensing information, the type of a sensor by which the first sensing information is obtained. In this case, the determiner 114 may compare the first sensing information included in a received transmitted signal with second sensing information obtained by a sensor of the same type as the type of the sensor included in the received transmitted signal or of a type having a correlation therewith.

For example, the beacon signal generator 109 may select one or a plurality of pieces of sensing information as first sensing information from a plurality of pieces of sensing information, and generate a beacon signal including the selected first sensing information and the type of a sensor by which the selected first sensing information is obtained.

Thus, the beacon signal as a transmitted signal includes the first sensing information selected from a plurality of pieces of sensing information obtained by measurement by a plurality of sensors placed on an object and the type of the sensor by which the selected first sensing information is obtained. In this case, similarly to the above, the determiner 114 may compare the first sensing information included in the received transmitted signal with the second sensing information obtained by a sensor of the same type as the type of the sensor by which this first sensing information is obtained or of a type having a correlation therewith. Similarly, for example, the beacon signal generator 109 may generate a beacon signal including a plurality of pieces of first sensing information and the types of sensors by which the plurality of pieces of first sensing information are obtained.

Thus, the transmitted signal includes a plurality of pieces of first sensing information obtained by measurement by a plurality of sensors placed on an object and the types of sensors by which the plurality of pieces of first sensing information are obtained.

In this case, the determiner 114 compares, with respect to each of the plurality of pieces of first sensing information included in the received transmitted signal, first sensing information with the second sensing information obtained by a sensor of the same type as the type of a sensor by which this first sensing information is obtained or of a type having a correlation therewith.

For example, a case is assumed where the first sensing information is a first characteristic amount extracted from measurement values of a first sensor, and the transmitted signal further includes, in addition to the first characteristic amount, characteristic amount type information indicating the type of the first characteristic amount. In this case, for example, the determiner 114 may extract a characteristic amount of the same type as the type of the first characteristic amount indicated by the characteristic amount type information included in the received transmitted signal or of a type having a correlation therewith as a second characteristic amount from measurement values of a second sensor. Then, the determiner 114 may compare the first characteristic amount with the second characteristic amount.

However, if the type of a characteristic amount to be sent is determined in advance, the type of the characteristic amount need not be transmitted.

Further, if the type of biometrics information to be sent is determined in advance, the type of the biometrics information need not be transmitted.

As another example, the hub may transmit a plurality of characteristic amounts. In this case, information indicating the type of biometrics information (for example, pulse wave) from which each characteristic amount is obtained and information indicating the type of the characteristic amount (for example, peak interval) may be included together in the beacon.

In this case, the node may extract at least one characteristic amount corresponding to the combination of the type of biometric information and the type of the characteristic amount which are received, and may compare the extracted characteristic amount with the corresponding characteristic amount received.

That is, one and another characteristic amount may be compared to make a determination, or one and another plurality of characteristic amounts may be compared to make a determination.

The type of biometrics information which can be measured and/or the type of a characteristic amount differs depending on the region where the node is placed (for example, a tip of a hand, a tip of a foot). Thus, the node may change a sensor used for obtaining sensing information depending on the region where the node itself is placed. Accordingly, the node can change the type of biometrics information to be compared depending on the region where the node itself is placed. For example, a node on a tip of a hand may compare pulse waves, and a node in the vicinity of a chest may compare heart rates.

Further, the node may change the type of a characteristic amount depending on the region where the node itself is placed. For example, a node on a tip of a hand may compare peak intervals, and a node on a tip of a foot may compare rising angles.

Further, the region where a node is placed may be specified from outside by the user.

For example, the node may include an input part (for example, a button provided for every region) specifying the region where the own device is placed. For example, when a node is placed on a foot, the node may specify that the own device is placed on the foot by a press of the button corresponding to the foot by the user.

As described above, the communication device 2 as a node may further have an input part accepting the region where the communication device 2 is placed from the user. In this case, the determiner 114 may change the type of the second sensing information compared with the first sensing information by using a region accepted by this input part. Here, the change of the type of the second sensing information is, for example, a change of a sensor used for obtaining the second sensing information. Alternatively, the change of the type of the second sensing information is, for example, a change of the type of a second characteristic amount extracted from measurement values of the second sensor.

Further, a sensor to be mounted may be set depending on the region where the node is placed. For example, there may be a node for foot and a node for hand. In this case, for example, only a sensor capable of measuring on a foot may be mounted in the node for foot, and a sensor capable of measuring on a hand may be mounted in the node for hand.

Note that a program for executing every processing of the communication devices (1, 1a, 1b, 1c, 1d) or the communication devices (2, 2c, 2d) of the embodiments may be recorded in a computer readable recording medium. The program recorded in this recording medium may be read in a computer system and executed by a processor, so as to perform the above-described various types of processing related to the communication device 1 or the communication device 2 of the embodiments.

### Sixth Embodiment

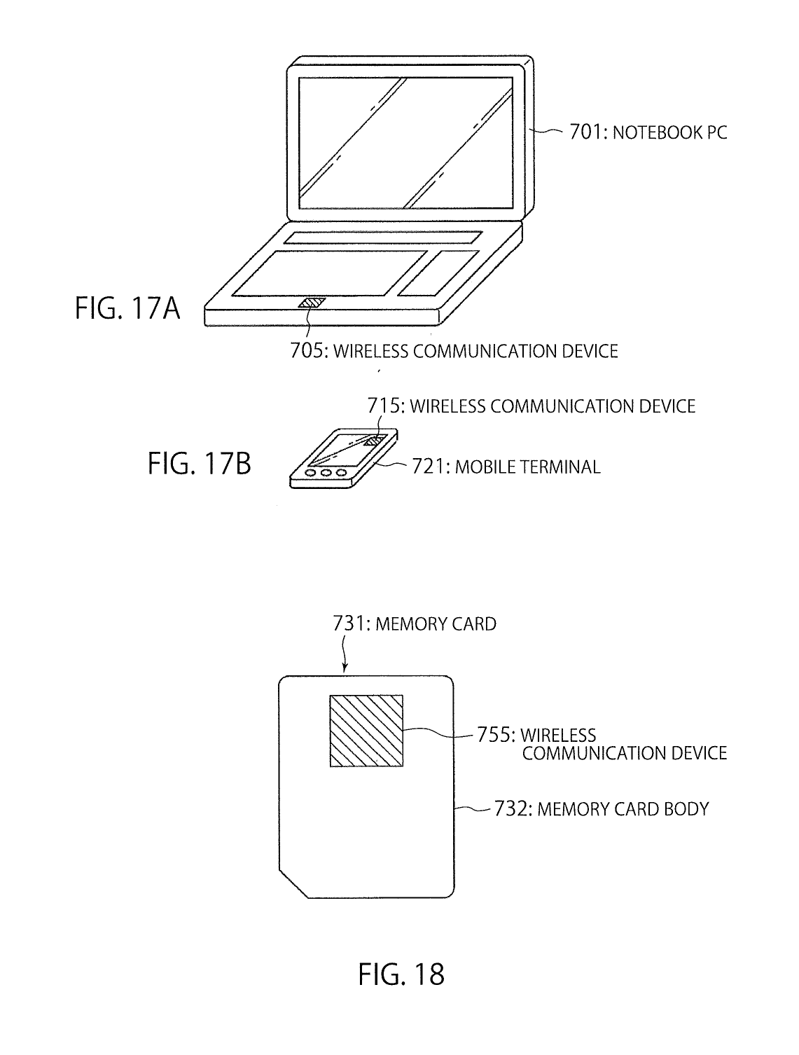

FIG. 17A and FIG. 17B are perspective views of wireless communication terminals according to a sixth embodiment. The wireless communication terminal of FIG. 17A is a notebook PC 701, and the wireless communication terminal of FIG. 17B is a mobile terminal 721. They each correspond to one mode of terminal (which may operate as either a base station or a child station). In the notebook PC 701 and the mobile terminal 721, a wireless communication device 705 and a wireless communication device 715 are mounted respectively. As the wireless communication devices 705, 715, the wireless communication devices as have been described can be used. The wireless communication terminals with the communication device mounted are not limited to the notebook PC and the mobile terminal. For example, the communication device may be mounted in a TV, a digital camera, a wearable device, a tablet, a smartphone, a game device, a network storage device, a monitor, a digital audio player, a Web camera, a video camera, a projector, a navigation system, an external adapter, an internal adapter, a set top box, a gateway, a printer server, a mobile access point, a router, an enterprise/service provider access point, a portable device, a handheld device, or the like.

Further, the wireless communication device can be mounted in a memory card. An example of mounting the wireless communication device in a memory card is illustrated in FIG. 18. A memory card 731 includes a wireless communication device 755 and a memory card body 732. The memory card 731 uses a wireless communication device 735 for wireless communication with an external device. Note that in FIG. 18, a description of other elements in the memory card 731 (for example, a memory or the like) is omitted.

### Seventh Embodiment

A seventh embodiment includes a bus, a processor part, and an external interface part in addition to the configuration of the wireless communication device according to any one of the first to sixth embodiments. The processor part and the external interface part are connected to a buffer via a bus. Firmware operates in the processor part. With a configuration thus including the firmware in the wireless communication device, a change of function of the wireless communication device can be performed easily by rewriting the firmware. The processor part in which the firmware operates may be a processor performing processing of a communication control device or a controller according to this embodiment, or another processor performing processing related to a functional expansion or a change of this processing. The processor part in which the firmware operates may be provided in a hub or a wireless terminal according to this embodiment. Alternatively, this processor part may be provided in an integrated circuit in the wireless communication device mounted in a hub or an integrated circuit in the wireless communication device mounted in the wireless terminal.

### Eighth Embodiment

An eighth embodiment includes a clock generator in addition to the configuration of the wireless communication device according to any one of the first to sixth embodiments. The clock generator generates clocks and outputs clocks to the outside of the wireless communication device via an output terminal. The clocks thus generated in the wireless communication device are outputted to the outside to allow a host side to operate by the clocks outputted to the outside, the host side and the wireless communication device side can be operated in synchronization.

### Ninth Embodiment

A ninth embodiment includes, in addition to the configuration of the wireless communication device according to any one of the first to sixth embodiments, a power supply, a power supply controller, and a wireless power feeding part. The power supply controller is connected to the power supply and the wireless power feeding part, and performs control to select a power supply to supply the wireless communication device. The configuration thus including the power supply in the wireless communication device enables low power consuming operation controlling the power supply.

### Tenth Embodiment

A tenth embodiment includes a SIM card in addition to the configuration of the wireless communication device according to the ninth embodiment. The SIM card is connected to, for example, a MAC processor or a controller or the like in the wireless communication device. The configuration thus including the SIM card in the wireless communication device enables to easily perform authentication processing.

### Eleventh Embodiment

An eleventh embodiment includes a moving image compression/expansion part in addition to the configuration of the wireless communication device according to the seventh embodiment. The moving image compression/expansion part is connected to a bus. The configuration thus including the moving image compression/expansion part in the wireless communication device enables to easily perform transmission of compressed moving image and expansion of received compressed moving image.

### Twelfth Embodiment

A twelfth embodiment includes an LED part in addition to the configurations of the wireless communication devices according to the first to eleventh embodiments. The LED part is connected to, for example, the MAC processor, the transmission processing circuit, the reception processing circuit, or the control circuit or the like in the wireless communication device. The configuration thus including the LED part in the wireless communication device enables to easily notify the user of the operating state of the wireless communication device.

### Thirteenth Embodiment

A thirteenth embodiment includes a vibrator in addition to the configuration of the wireless communication device according to any one of the first to sixth embodiments. The vibrator is connected to, for example, the MAC processor, the transmission processing circuit, the reception processing circuit, or the control circuit or the like in the wireless communication device. The configuration thus including the vibrator in the wireless communication device enables to easily notify the user of the operating state of the wireless communication device.

### Fourteenth Embodiment

A fourteenth embodiment includes a display in addition to the configuration of the wireless communication device according to any one of the first to sixth embodiments. The display is connected to, for example, a MAC processor of a wireless communication device via a not-illustrated bus. The configuration thus including the display in the wireless communication device and displaying the operating state of the wireless communication device on the display enables to easily notify the user of the operating state of the wireless communication device.

### Fifteenth Embodiment

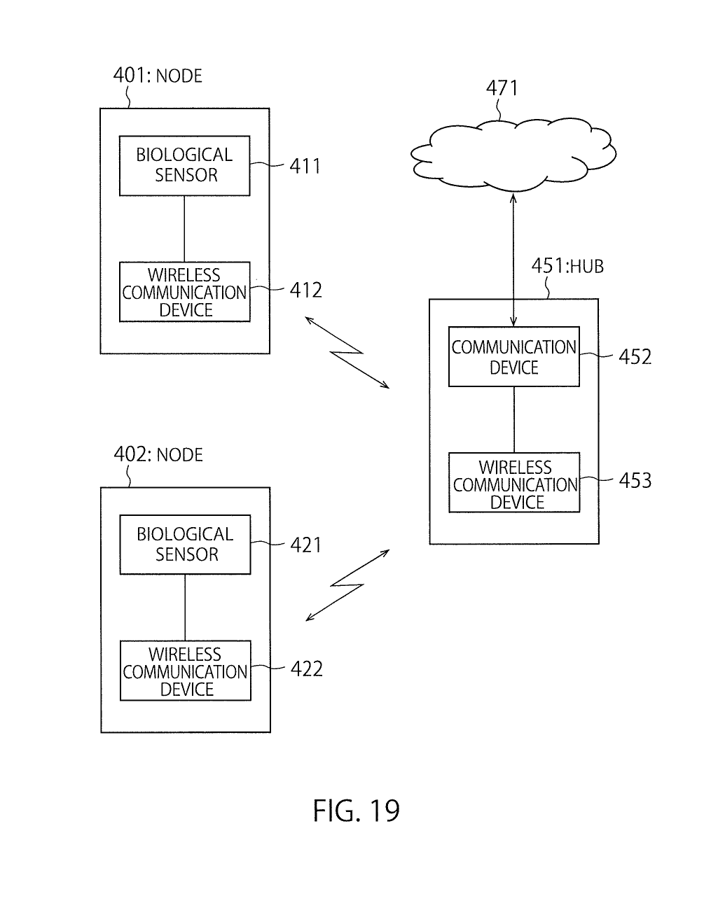

FIG. 19 illustrates an overall configuration of a wireless communication system according to a fifteenth embodiment. This wireless communication system is an example of a body area network. The wireless communication system includes a plurality of nodes including nodes 401, 402 and a hub 451. Each of the nodes and the hub are attached to a human body, and each node performs wireless communication with the hub 451. Attaching to a human body may include any case of placing in a position close to a human body, such as mode of directly contacting a human body, mode of attaching over clothes, mode provided on a thread worn around a neck, mode fitting in a pocket, and the like. The hub 451 is, as one example, a terminal such as a smartphone, a mobile phone, a tablet, or a notebook PC.

The node 401 includes a biological sensor 411 and a wireless communication device 412. As the biological sensor 411, for example, a sensor sensing body temperature, blood pressure, pulse wave, electrocardiogram, heart rate, blood oxygen level, glucose in urine, or blood glucose, or the like can be used. However, a sensor sensing biological data other than them may be used. The wireless communication device 412 is a wireless communication device of any one of the embodiments which have been described. The wireless communication device 412 performs wireless communication with a wireless communication device 453 of a hub 451. The wireless communication device 412 wirelessly transmits biological data (sensing information) sensed by the biological sensor 411 to the wireless communication device 453 of the hub 451. The node 401 may be configured as a device in a tag form.

The node 402 includes a biological sensor 421 and a wireless communication device 422. The biological sensor 421 and the wireless communication device 422 are the same as the biological sensor 411 and the wireless communication device 412 of the node 401, and thus their explanation is omitted.

The hub 451 includes a communication device 452 and a wireless communication device 453. The wireless communication device 453 performs wireless communication with the wireless communication device of each node. The wireless communication device 453 may be the wireless communication device of any one of the embodiments which have been described, or may be a different wireless communication device from the embodiments which have been described as long as it is capable of communicating with the wireless communication device of the node. The communication device 452 is connected to a network 471 via wire or wirelessly. The network 471 may be a network such as the Internet or a wireless LAN, or may be a hybrid network of a wired network and a wireless network. The communication device 452 transmits data collected from respective nodes by the wireless communication device 453 to a device on the network 471. Delivery of data from the wireless communication device 453 to the communication device may be performed via a CPU, a memory, an auxiliary storage, and/or the like. The device on the network 471 may be, specifically, a server device storing data, a server device analyzing data, or any other server device. In the hub 451, a biological sensor similarly to the nodes 401, 402 may be mounted. In this case, the hub 451 transmits data obtained by the biological sensor to the device on the network 471 via the communication device 452. An interface in which a memory card such as an SD card is inserted may be mounted in the hub 451, and data obtained by the biological sensor or data obtained from respective nodes may be stored in the memory card. Further, in the hub 451, a user input part by which the user inputs various instructions and a display part displaying data and so on by image may be mounted.

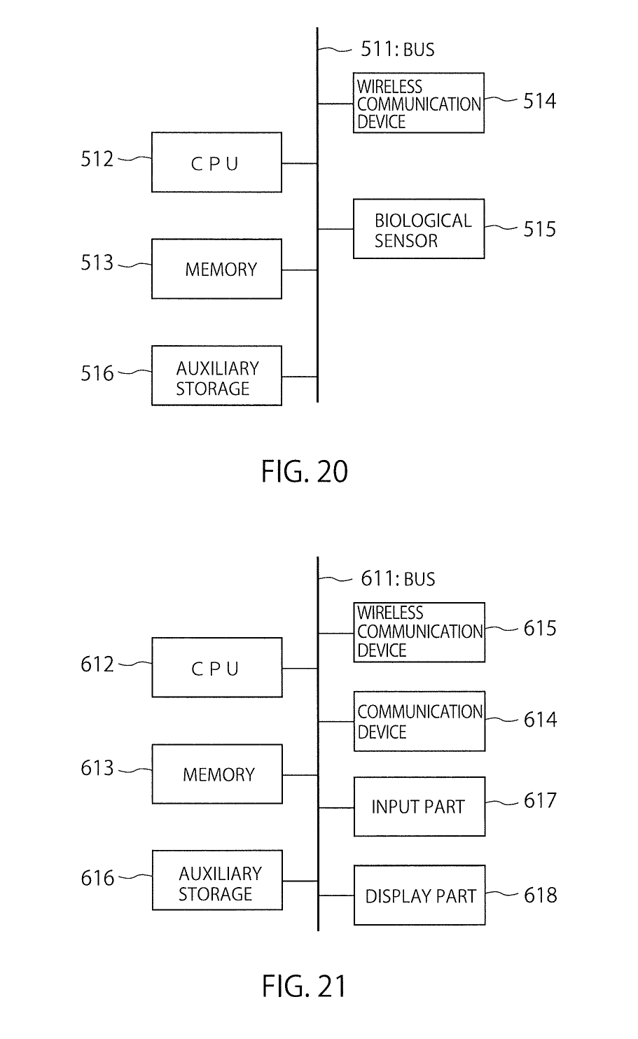

FIG. 20 is a block diagram illustrating a hardware configuration example of the node 401 or the node 402 illustrated in FIG. 19. A CPU 512, a memory 513, an auxiliary storage 516, a wireless communication device 514, and a biological sensor 515 are connected to a bus 511. Here, the respective parts 512 to 516 are connected to one bus. However, a plurality of buses may be provided via a chipset or the like, where the parts 512 to 516 may be connected in a manner of being distributed to the plurality of buses. The wireless communication device 514 corresponds to the wireless communication devices 412, 422 of FIG. 19, and the biological sensor 515 corresponds to the biological sensors 411, 421 of FIG. 19. The CPU 512 controls the wireless communication device 514 and the biological sensor 515. The auxiliary storage 516 is a device permanently storing data, such as an SSD or a hard disk. The auxiliary storage 516 stores a program executed by the CPU 512. Further, the auxiliary storage 516 may store data obtained by the biological sensor 515. The CPU 512 reads the program from the auxiliary storage 516 and develops the program in the memory 513 to execute the program. The memory 513 may be a volatile memory such as a DRAM, or a non-volatile memory such as an MRAM. The CPU 512 drives the biological sensor 515, stores data obtained by the biological sensor 515 in the memory 513 or the auxiliary storage 516, and transmits the data to the hub via the wireless communication device 514. The CPU 512 may execute processing of a communication protocol or an application layer which is higher in order than the MAC layer.

FIG. 21 is a block diagram illustrating a hardware configuration example of the hub 451 illustrated in FIG. 19. A CPU 612, a memory 613, an auxiliary storage 616, a communication device 614, a wireless communication device 615, an input unit 617, and a display part 618 are connected to the bus 611. Here, the respective parts 612 to 617 are connected to one bus. However, a plurality of buses may be provided via a chipset or the like, where the parts 612 to 617 may be connected in a manner of being distributed to the plurality of buses. A biological sensor or a memory card interface may be further connected to the bus 611. The input part 617 accepts an input of various instructions from the user, and outputs a signal of the inputted instruction to the CPU 612. The display part 618 displays data and the like instructed by the CPU 612 by image. The communication device 614 and the wireless communication device 615 correspond to the communication device 452 and the wireless communication device 453, respectively, which the hub of FIG. 19 includes. The CPU 612 controls the wireless communication device 615 and the communication device 614. The auxiliary storage 616 is a device, such as an SSD or a hard disk, permanently storing data. The auxiliary storage 616 stores a program executed by the CPU 612, and may further store data received from the respective nodes. The CPU 612 reads the program from the auxiliary storage 616 and develops the program in the memory 613 to execute it. The memory 613 may be a volatile memory such as a DRAM, or a non-volatile memory such as an MRAM. The CPU 612 stores data received from the respective nodes in the wireless communication device 615 in the memory 613 or the auxiliary storage 616, and transmits the data to the network 471 via the communication device 614. The CPU 612 may execute processing of a communication protocol or an application layer which is higher in order than the MAC layer.

The terms used in this embodiment should be construed broadly. For example, the term “processor” may encompass a general-purpose processor, a central processing unit (CPU), a microprocessor, a digital signal processor (DSP), a controller, a microcontroller, a state machine, and the like. Depending on the circumstance, the “processor” may also refer to an application specific integrated circuit, a field programmable gate array (FPGA), a programmable logic device (PLD), or the like. The “processor may also refer to a combination of processing devices such as a plurality of microprocessors, a combination of a DSP and a microprocessor, or one or more microprocessor cooperating with a DSP core.

As another example, the term “memory” may encompass any electronic parts capable of storing electronic information. The “memory” may also refer to a random access memory (RAM), a read-only memory (ROM), a programmable read-only memory (PROM), an erasable programmable read-only memory (EPROM), an electrically erasable PROM (EEPROM), a non-volatile random access memory (NVRAM), a flash memory, a magnetic or optical data storage, and they can be read by the processor. When the processor perform reading or writing information from or to the memory or performing the both of them, it can be said that the memory electrically communicates with the processor. The memory may be integrated with the processor, and also in this case, it can be said that the memory electrically communicates with the processor.

It should be noted that the present invention is not limited to the above-described embodiments as they are, but can be embodied with components being modified within the range not departing from the spirit thereof in the stage of implementation. Further, various inventions can be formed by appropriately combining a plurality of components disclosed in the above-described embodiments. For example, some components may be deleted from all the components described in the embodiments. Moreover, components ranging across different embodiments may be combined appropriately.

1. A wireless communication device, comprising
a receiver configured to receive a first signal obtained by a first sensor;
processing circuitry configured to compare first sensing information included in the first signal with second sensing information obtained by a second sensor so as to determine whether or not the first sensing information and the second sensing information are obtained from a same target object; and
a transmitter configured to transmit, when it is determined that the first sensing information and the second sensing information are obtained from the same target object, a wireless connection signal to connect one of an own device and an other communication device which has transmitted the first signal to a wireless network formed by the other of the own device and the other communication device.

2. The wireless communication device according to claim 1, wherein:
the first sensing information is a first characteristic amount extracted from measurement values of the first sensor; and
the processing circuitry extracts a second characteristic amount as the second sensing information from measurement values of the second sensor, and compares the first characteristic amount with the second characteristic amount.

3. The wireless communication device according to claim 1, wherein:
the first sensing information and the second sensing information are obtained by measurement by sensors of same types; and
when the first sensing information and the second sensing information coincide, the processing circuitry determines that the first sensing information and the second sensing information are obtained from the same target object.

4. The wireless communication device according to claim 3, wherein
the receiver receives the first signals transmitted from a plurality of other communication devices;
when signals in which the first sensing information and the second sensing information coincide do not exist among the plurality of first signals received during a prescribed period, the processing circuitry selects a communication device which transmitted the first signal including sensing information which is closest to the second sensing information from the plurality of first signals; and
the transmitter transmits the wireless connection signal to the selected communication device.

5. The wireless communication device according to claim 2, wherein:
the first sensor and the second sensor are sensors of different types whose measurement values have a correlation with each other; and
the processing circuitry compares a variation pattern of the measurement values of the first sensor with a variation pattern of the measurement values of the second sensor.

6. The wireless communication device according to claim 1, wherein:
the first sensing information is a hash value of measurement values of the first sensor or a hash value of a first characteristic amount extracted from the measurement values of the first sensor; and
the processing circuitry decides a hash value of measurement values of the second sensor or a hash value of a second characteristic amount extracted from the measurement values of the second sensor as the second sensing information.

7. The wireless communication device according to claim 1, wherein
the first sensing information is included in the first signal for a certain period of time based on a trigger input from a user accepted by the other communication device.

8. The wireless communication device according to claim 1, wherein:
the processing circuitry obtains the second sensing information by using the second sensor; and
the other communication device includes the first sensor.

9. The wireless communication device according to claim 1, wherein
the processing circuitry obtains the second sensing information by using the second sensor,
a third communication device already connected to the wireless network includes the first sensor, and
the first sensing information received by the receiver is information obtained by the other communication device through communication from the third communication device.

10. The wireless communication device according to claim 1, wherein:
the other communication device forms the wireless network; and
the wireless connection signal is a connection request signal requesting for connection to the first communication device.

11. The wireless communication device according to claim 1, wherein:
the own device forms the wireless network;
the first signal is a probe request signal; and
the wireless connection signal is a probe response signal responding to the probe request signal.

12. The wireless communication device according to claim 1, wherein:
the first signal further includes, in addition to the first sensing information, a type of a sensor by which the first sensing information is obtained; and
the processing circuitry compares the first sensing information included in the first signal with the second sensing information obtained by a sensor of a same type as the type of the sensor included in the first signal or of a type having a correlation therewith.

13. The wireless communication device according to claim 12, wherein
the processing circuitry obtains the second sensing information by using a plurality of types of the second sensor;
the other communication device includes a plurality of types of sensors as the first sensor; and
the first signal includes the first sensing information selected from a plurality of pieces of sensing information obtained by measurement by the plurality of sensors and a type of a sensor by which the selected first sensing information is obtained.

14. The wireless communication device according to claim 12, wherein
the processing circuitry obtains the second sensing information by using a plurality of types of the second sensor;
the other communication device includes a plurality of types of sensors as the first sensor;
the first signal includes a plurality of pieces of first sensing information obtained by measurement by the plurality of sensors and a type of a sensor by which the plurality of pieces of first sensing information are obtained; and
the processing circuitry compares, with respect to each of the plurality of pieces of first sensing information included in the first signal, first sensing information with the second sensing information obtained by a sensor of a same type as a type of a sensor by which the first sensing information is obtained or of a type having a correlation therewith.

15. The wireless communication device according to claim 1, wherein:
the first sensing information is a first characteristic amount extracted from measurement values of the first sensor;
the first signal further includes, in addition to the first characteristic amount, characteristic amount type information indicating a type of the first characteristic amount; and
the processing circuitry extracts a characteristic amount of a same type as the type of the first characteristic amount indicated by the characteristic amount type information included in the first signal or of a type having a correlation therewith as a second characteristic amount from measurement values of the second sensor, and compares the first characteristic amount with the second characteristic amount.

16. The wireless communication device according to claim 1, wherein:
the processing circuitry accepts information of a region where the own device is placed from a user via an input part; and
the processing circuitry changes by using the information of the region a type of the second sensing information compared with the first sensing information.

17. The wireless communication device according to claim 1, wherein:
the object is a human; and
the first sensing information and the second sensing information are biometrics information obtained from a same person.

18. A wireless communication terminal comprising:
at least one antenna; and
the wireless communication device according to claim 1.

19. A wireless communication terminal comprising:
the wireless communication device according to claim 1; and
the second sensor.

20. A wireless communication method by using a wireless communication terminal, the wireless communication method comprising:
receiving a first signal obtained by a first sensor;
comparing first sensing information included in the first signal with second sensing information obtained by a second sensor so as to determine whether or not the first sensing information and the second sensing information are obtained from a same target object; and
transmitting, when it is determined that the first sensing information and the second sensing information are obtained from the same target object as a result of the determination, a wireless connection signal to connect one of an own device and an other communication device which has transmitted the first signal to a wireless network formed by the other of the own device and the other communication device.
